(19) United States
(12) Patent Application Publication
(10) Pub. No.: US 2018/0200661 A1
(43) Pub. Date: Jul. 19, 2018

(54) SOLAR ASSISTED LARGE SCALE CLEANING SYSTEM

(71) Applicants: David Y.H. Pui, Medina, MN (US); Sheng-Chieh Chen, Saint Paul, MN (US); Thomas H. Kuehn, Mahtomedi, MN (US); Charles Sing-Keung Lo, Little Canada, MN (US)

(72) Inventors: David Y.H. Pui, Medina, MN (US); Sheng-Chieh Chen, Saint Paul, MN (US); Thomas H. Kuehn, Mahtomedi, MN (US); Charles Sing-Keung Lo, Little Canada, MN (US)

(21) Appl. No.: 15/314,874

(22) PCT Filed: Sep. 2, 2016
(86) PCT No.: PCT/US2016/050296

§ 371 Date: Nov. 29, 2016

Related U.S. Application Data
(60) Provisional application No. 62/213,895, filed on Sep. 3, 2015.
(60) Provisional application No. 62/276,589, filed on Jan. 8, 2016.

(51) Int. Cl. B01D 47/06; B01D 47/02; B01D 45/02; B01D 45/10; B01D 50/00; B01D 45/18; B01D 53/00

(52) U.S. Cl. CPC B01D 47/06; B01D 47/028; B01D 45/02; B01D 45/10; B01D 50/006; B01D 2247/08; B01D 53/007; B01D 2247/04; B01D 2259/804; B01D 2247/02; B01D 45/18

(57) ABSTRACT

An adaptive spray cleaning system includes a gas tunnel having a gas inlet and a gas outlet. A sprayer assembly is between the gas inlet and the gas outlet. The sprayer assembly includes at least one sprayer array having at least one spray nozzle. The at least one spray nozzle is directed into the gas tunnel. The sprayer assembly includes at least one variable spray configuration characteristic. A sprayer assembly control system is coupled with the at least one sprayer array. The sprayer assembly control system includes one or more sensors proximate at least one of the gas inlet or the gas outlet. The one or more sensors are configured to measure a pollutant characteristic. A controller is in communication with the one or more sensors and the sprayer assembly. The controller is configured to control the at least one variable spray configuration characteristic according to the measured pollutant characteristic.

### CLAIM OF PRIORITY

This patent application claims the benefit of priority to Pui et al., U.S. Provisional Patent Application Ser. No. 62/213,895, entitled “SOLAR ASSISTED LARGE SCALE CLEANING SYSTEM”, filed on Sep. 3, 2015 (Attorney Docket No. 600.985PRV), which is hereby incorporated by reference herein in its entirety.

Further, this patent application claims the benefit of priority to Pui et al., U.S. Provisional Patent Application Ser. No. 62/276,589, entitled “SOLAR ASSISTED LARGE SCALE CLEANING SYSTEM”, filed on Jan. 8, 2016 (Attorney Docket No. 600.985PV2), which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Regents of the University of Minnesota; Minneapolis, Minn. All Rights Reserved.

### TECHNICAL FIELD

This document pertains generally, but not by way of limitation, to cleaning systems for the removal of particulates, micro-organisms and gases from atmospheric air and process gases.

### BACKGROUND

Atmospheric pollutants include a variety of different particulate and fluid based pollutants suspended in the atmosphere. Atmospheric pollutants are generated by industrial processes, automotive exhaust and other activities associated with urban and industrial centers. In at least some examples atmospheric pollutants create an undesirable haze, especially over urban or industrial centers. In other examples, atmospheric pollutants introduce irritating or noxious odors.

One example of a particulate pollutant includes PM_{2.5}. PM_{2.5} refers to the mass concentration of particulate matter (PM) in air that is less than 2.5 microns in aerodynamic diameter. Ambient air requirements for the U.S. were established in 1997 by the U.S. Environmental Protection Agency (USEPA) to protect public health. The standard has been progressively strengthened over the years and is currently set at 35 μg/m³ over a 24-h period and 12 μg/m³ for annual average in the U.S. PM_{2.5} includes fine particles of air pollutants primarily resulting from combustion and gas-to-particle conversion processes in the atmosphere. The principal sources include coal-oil-gasoline-diesel-wood combustion, high temperature industrial processes from smelters and steel mills, vehicle emissions, and biomass burning. Due to small particle size of PM_{2.5} they have a life-time of days to weeks in the atmosphere and may travel over thousands of kilometers (e.g., by prevailing winds). A significant fraction of the particles in PM_{2.5} have particle diameters near the wavelength of light and accordingly scatter light causing visibility reduction. In some examples PM_{2.5} is captured within the human respiratory tract and may cause lung disease, heart disease and premature death.

In one example, PM_{2.5} is removed or reduced in air by filtering the polluted air using filter media, baghouse filters, electrostatic precipitators or the like. Particulate such as PM_{2.5} is trapped in the filters and the air is delivered from the filter in a cleaned state. In another example, the polluted air is passed between electrostatically charged plates and the ionized particulate is collected along a grounded plate.

### OVERVIEW

The present inventors have recognized, among other things, that a problem to be solved can include failing to dynamically adjust to changes in pollutants, such as concentration of pollutants, the type of pollutant or the like in the atmosphere or process gas. In some examples the concentration and types of pollutants change according to one or more of the time of day (e.g., rush hour), day of the week (e.g., work days) or the season. Example filter systems including filter media, baghouse filters and electrostatic precipitators are in some examples statically configured to handle specified types of pollutants and concentrations of those pollutants at the time of their construction. For example, variation in pollutant concentration causes one or more of premature fouling of filters, early and repeated filter replacement or washing of plates of electrostatic precipitators along with attendant downtime and labor for replacement and cleaning.

The present subject matter can help provide a solution to this problem, such as by cleaning systems configured to process pollutant loaded atmosphere. As described herein, in one example an adaptive spray cleaning system (e.g., a controlled precipitator) is configured to dynamically change its operation (e.g., one or more spray characteristics) in response to variations in pollutant concentration or type. The system includes one or more spray nozzles of a sprayer assembly. The sprayer assembly (e.g., controlled precipitator) includes at least one spray configuration characteristic adjustable between at least first and second sprayer configurations. Optionally, the first and second sprayer configurations include a plurality of configurations (e.g., a range, continuum or the like) that facilitates the dynamic change of the sprayer assembly according to changes in the incoming polluted fluid (e.g., polluted air, process gas or the like). Example spray configuration characteristics include, but are not limited to, the number of operating spray nozzles; spray nozzle locations (e.g., including locations within a spray tunnel, orientation or direction of nozzles or the like); nozzle type (e.g., different or adjustable nozzles for varied drop size); multiple stage nozzles, such as first stage nozzles for a first drop size (large) and second stage nozzles for a second drop size (small); chemical additives (to facilitate the breakdown of pollutants in the air; aesthetic and tracing additives (e.g., aromas, medicinal additives (eucalyptus) and aromas that facilitate the tracking of cleaned air).

In one example, the sprayer assembly includes a plurality of spray nozzles as described herein. The plurality of spray nozzles are configured to shower incoming air including particulate (e.g., PM_{2.5}) with a liquid, such as water. The showered liquid entrains the particulate and effectively removes the particulate from the air. The water with the entrained particulate is received in a liquid collection trough, basin, sump or the like. Optionally, the liquid is treated (e.g., strained, treated or the like) to remove the particulate and recycle the liquid for use again in the shower array.

The adaptive spray cleaning system in examples uses a plurality of modular single-stage or multi-stage arrays of spray nozzles to generate showers (sprays) to remove or treat the pollutants in incoming gas (e.g., air) thus cleaning it. The adaptability of the adaptive spray cleaning system increases efficiency, and facilitates scaling from a small (1 cubic meter per minute) system to a large scale (multi million cubic meters per minute) system. By operating the systems described herein with one or more spray angles, spray droplet sizes, spray flow rates, chemistry of the spray liquid and the arrangement of the spray nozzle arrays, the adaptive spray cleaning systems described herein are configured to adaptively remove or treat different sizes and concentration of particulates, micro-organisms and gases. The systems described herein are configurable to use a single-stage or multiple stages (e.g., of sprayer arrays) with each stage optionally having variations in configuration (nozzle size, angle, density of nozzles or the like), operating parameters (flow rate, selection and operation of one or more arrays of nozzles or the like) and different spray liquid (e.g., differing additives, differing carrier fluids, temperature of the liquid, flow rates of the liquid or the like) to enhance the particle and gas pollutant removal efficiencies.

Additionally, further options for the systems are included in some examples. For instance, an electrostatic charge is applied to the droplets to facilitate adhesion to specified pollutants. In another example, chemical additives are added to the spray liquid to enhance particle, micro-organism and other pollutant removal. In still other examples, the systems described herein are used in combination with electrostatic precipitators and catalytic materials (e.g., photo-catalytic materials or the like) to further enhance pollutant treatment or removal.

The present inventors have further recognized, among other things, that a problem to be solved can include decreasing high pollutant concentration from the atmosphere, including gaseous pollutants such as carbon dioxide or the like, resulting from fossil fuel burning and other industrial processes.

The present subject matter can help provide a solution to this problem, such as by the sprayer assembly as part of an adaptive spray cleaning system. The spray assembly provides one or more spray fluid streams (e.g., atomized drops of the spray fluid) to intercept a moving stream of polluted gas. The spray fluid includes one or more pollutant catalyzing or capturing additives (e.g., carbon dioxide capture media) configured to react with the pollutants in the gas and remove the pollutants from the gas. The cleaned gas (e.g., air) exits the system with a minimized concentration of one or more pollutants and is exhausted. The components of the pollutants, such as carbon dioxide (components of the capture media bound with the carbon dioxide components), sulfur dioxide or the like are optionally processed to recycle the additives (e.g., for continued capture of the carbon dioxide) and allow for storage or disposal of the captured pollutant components.

Each of the embodiments provided herein are optionally scaled to sizes for use in buildings and up to and beyond a kilometer or more (in one example a tapered shroud that funnels ambient air toward the sprayer assembly has a diameter of a kilometer or more) to facilitate cleaning of the atmosphere on a corresponding large scale. The use of renewable resources including water and solar power minimizes (eliminates or minimizes) the energy input needed for the system. Further, the system optionally does not use filters that require disposal and replacement.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an adaptive spray cleaning system.

FIG. 2 is a schematic view of another example of an adaptive spray cleaning system.

FIG. 3A is a schematic view of one example of a horizontal gas tunnel including an adaptive spray cleaning system.

FIG. 3B is a schematic view of one example of a vertical gas tunnel including an adaptive spray cleaning system.

FIG. 4A is a plan view showing one example of a sprayer assembly including a plurality of nozzle arrays.

FIG. 4B is a side view showing another example of a sprayer assembly including a plurality of nozzle arrays.

FIG. 4C is a side view showing another example of a sprayer assembly including a plurality of nozzle arrays.

FIG. 4D is a side view showing another example of a sprayer assembly including a plurality of nozzle arrays.

FIG. 5A is a cross sectional schematic view of a first example of a sprayer nozzle configured to deliver a first droplet size.

FIG. 5B is a cross sectional schematic view of a second example of a sprayer nozzle configured to deliver a second droplet size.

FIG. 6 is a schematic view of one example of a spray fluid control module.

FIG. 7 is a schematic view of one example of an inline spray fluid cleaning system configured to clean the fluid.

FIG. 8 is a schematic view of another example of an adaptive spray cleaning system as a cooperative component of a heat rejecting system.

FIG. 9 is a schematic view of yet another example of an adaptive spray cleaning system as a component of a building ventilation system.

FIG. 10 is a block diagram showing one example of a method for adaptively cleaning a stream of polluted gas.

FIG. 11A is a perspective view of one example of an adaptive spray cleaning system.

FIG. 11B is a schematic view of the adaptive spray cleaning system shown in FIG. 11A.

FIG. 12A is a top view of another example of an adaptive spray cleaning system.

FIG. 12B is a perspective view of one example of a sprayer assembly including a nozzle array used with the adaptive spray cleaning system shown in FIG. 12A.

FIG. 12C is a schematic view of a portion of the adaptive spray cleaning system shown in FIG. 12A.

FIG. 12D is a schematic view of a liquid collection trough of the adaptive spray cleaning system shown in FIG. 12A.

FIG. 13 is a schematic view of an example electrostatic precipitator.

FIG. 14A is a schematic top view of an additional example of an adaptive spray cleaning system.

FIG. 14B is a schematic side view of the adaptive spray cleaning system shown in FIG. 14A.

### DETAILED DESCRIPTION

The adaptive spray cleaning systems described herein use a plurality of modular single-stage or multi-stage sprayer arrays to generate showers to treat pollutants in incoming gas (e.g., ambient air, gases generated from production processes such as power generation, manufacturing or the like) thus cleaning it. These designs provide adaptive and easily scalable gas cleaning systems. By selecting one or more variable spray configuration characteristics including, but not limited to, spray fluid (nozzle) orientation (e.g., angle), spray droplet size, spray fluid flow rate, chemistry of the spray liquid (e.g., composition, concentration of additives or the like) and the arrangement of the spray nozzle array (nozzle density, location or the like) the systems are adaptable to remove different sizes and concentrations of particulates, other pollutant components, such as micro-organisms and gaseous pollutants or the like. A multi-stage system including a plurality of sprayer arrays (whether in staggered locations or a consolidated location) provides each sprayer array with a different design, operating parameters and different spray liquid (e.g., one or more differing variable spray configuration characteristics) to enhance treatment of the polluted gas including increasing particle and gas pollutant removal efficiencies. The design adaptive spray cleaning systems described herein is modular and facilitates the selection and assembly of multiple modules (e.g., sprayer arrays, spray fluid supplies or the like) in parallel, in series or in a consolidated location along a gas tunnel to accommodate different operating conditions and applications.

Further enhancements to the cleaning performance are achieved with the incorporation of one or more of electrostatic charge to the droplets or the addition of pollutant treating additives to the spray fluid to enhance pollutant component (e.g., particle, micro-organisms and gaseous pollutants) removal. The adaptive spray cleaning systems described here are optionally used in combination with other cleaning technologies including, but not limited to, electrostatic precipitators, catalytic materials (e.g., photo-catalysts, nanomaterials or the like configured to react with one or more pollutant components). In addition, gas capture media can be added to the spray fluid to combine particle removal and gas removal functions (such as carbon dioxide removal) into a single system. The adaptive spray cleaning systems described herein overcome the shortcomings of filtering devices and have additional benefits in with regard to the streamlining of cleaning operations and maintenance complexity.

In one example, the mechanism for the removal of pollutant particles the systems described herein is by diffusion of the particles onto spray droplets. In an example, at relatively low air velocities particles have more time to diffuse onto the droplets (e.g., become entrained). The entrainment of the particulate provides a high removal efficiency, that increases with smaller diameter droplets. In one example, particle removal efficiency is quantified as the number of particles removed divided by the amount of spray liquid specified (e.g., used).

As described herein, the adaptive spray cleaning systems include one or more sprayer arrays each having one or more spray nozzles. The spray nozzles and the arrays generally are positioned and arranged based on application requirements. The arrangement of the arrays of spray nozzles and their selection (e.g., selected operation during use and control of the operated arrays) are matched to the polluted air flow pattern (flow velocity profile), pollutant components such as particles, micro-organisms, and gases, concentration patterns (concentration profile) of the pollutants in the air stream, and the specified pollutant removal efficiency. Additionally, the spray fluid, including its electrical properties and chemical properties, are optionally regulated (e.g., controlled) to further enhance pollutant treatment. Optionally, a multi-stage system including a plurality of varied sprayer arrays, spray fluids or the like are used separately, cooperatively or the like, for instance through a control system that regulates the operation and operating parameters (e.g., variable spray configuration characteristics) of the sprayer arrays and optionally the spray fluid. Each stage (e.g., array) may itself include a number of modules consisting of different numbers (density) of spray nozzles with similar or differing spray characteristics and different spray fluids with one or more of different electrical or chemical properties.

In at least some examples each nozzle in a component sprayer array includes a spray angle, spray fluid flowrate, droplet size and spray pattern (wide, narrow or the like). The nozzles are optionally separate components from the spray fluid distribution piping or tubing system or holes formed in the piping or tubing system itself. The spray nozzles the systems described herein are fed with spray fluid that is then drained after use from the system via gravity, a liquid pump or the like. Pumps for distributing the spray fluid to the nozzles, the chemistry of the spray fluid or the like are all optionally controlled remotely, for instance with a controller as described herein, thereby making each sprayer array (as well as component modules of sprayer arrays) selectively operable by automated control to respond dynamically to changing characteristics, such as measured or historical pollutant characteristics including, but not limited to, changing velocity profiles, concentration profiles, pollutant concentrations, pollutant types or the like.

The adaptive spray cleaning systems are optionally used with or as ventilation systems including one or more of residential, business and public ventilation system. Some residential HVAC systems have a media filter for removing particulate material and a separate humidifying system for adding moisture to the air during dry periods such as during the winter months. The adaptive spray cleaning systems described herein facilitate the combination of these otherwise separate features and provide benefits including decreased maintenance and improved performance.

For instance, by using the systems described herein aerosol particles are removed effectively and without the need of a media filter (including the cost and effort necessary for recommended periodic replacement). Conversely, many humidifiers use a material substrate (mesh or the like) to wick water from a basin or a fill material so that water runs down the substrate as the air passes through. These substrates become clogged with minerals and need periodic replacement. By using the adaptive spray cleaning systems the air is humidified and also filtered without the use of a wick, mesh fill material or filter media. Similarly, adaptive spray cleaning systems are optionally placed in commercial building air handling units (AHU) to replace filter banks and water or steam humidifier systems. By controlling the chemistry (e.g., composition, concentration of additives or the like) of the spray fluid droplets, the air passing through the unit is dehumidified (or humidified) which is needed in summer months. By placing the unit in a commercial building air handing system (AHU) upstream of the cooling coils, the system provides air filtration of particulate material and dry the air prior to entering cooling coils. The cooling coils are then operated as dry coils with no wet surfaces or wet drain pan that promotes microbial growth in some examples.

The nozzles in the adaptive spray cleaning systems are fed with the spray fluid, for instance from one or more spray fluid supplies. Typical spray fluid pressure is 10 psi water pressure. The used spray fluid is drained from the system via gravity or external liquid pumps. In addition to liquid pumps, valves or the like used to regulate the flow of the spray fluid (e.g., to the nozzles), the chemistry of the spray liquid is also optionally automatically controlled. Accordingly, the spray fluid supplies are optionally located remotely from the remainder of the adaptive spray cleaning systems. Further, because the adaptive spray cleaning systems are relatively low pressure systems with low probability of damage by pressure rupture, and a minimal possibility of generating electric sparks (that can cause combustion and/or explosion) these systems are readily adapted to clean the air in environments including, but not limited to, underground coal mines, grain elevators, ammunition plants, petro-chemical plants, chemical plants, or the like.

When the spray fluid, such as water, is recirculated through an adaptive spray cleaning system the spray fluid temperature will approach the incoming gas (e.g., air) wet bulb temperature (Thermal Environmental Engineering, 3^{rd} ed. Ch.10). The gas is then cooled and humidified as it passes through the spray fluid. The humidified and cooled gas has an increased density. To drive the exhausting gas toward a system outlet (e.g., gas outlet) the in an upflow natural draft system, the density of the gas entering the system must be less than that of the ambient gas (e.g., ambient air). In one example, the gas is heated prior to or after exiting the sprayer arrays.

In one example, the thermal energy added to the gas flowing through the system is provided by one or more of passive solar energy or by heat added to the air from heated spray fluid droplets. In some systems, hot water is used to remove heat from power plant condensers, various industrial processes and from the condensers of air conditioning chillers. Cooling towers are used to reject the heat to ambient air using direct contact between water and the air. The ultimate heat sink becomes the ambient air wet bulb temperature rather than the ambient dry bulb temperature and the wet bulb temperature is typically several degrees cooler than the dry bulb temperature. Hot water is also used in the adaptive spray cleaning systems (described herein) by using the system as a cooling tower. Heat from the hot water (e.g., hot spray fluid) is added to the air passing through the system to provide the thermal buoyant force to drive the airflow through a natural draft system. The water is simultaneously cooled in a manner similar to a wet cooling tower. The use of heated spray fluid (e.g., heated water) to provide thermal buoyancy optionally does not rely on fluctuations in solar energy or require thermal storage as is necessary to operate large scale air cleaning systems without a fan at night and during conditions of low solar radiation intensity. In some examples, the heated spray fluid is provided by one or more processes such as condensed power plant water or the like.

In other examples, wet cooling towers lose a percentage of the water that enters the system because of evaporation. Some portion of the loss is attributed to the carrying away of droplets by the leaving air stream (called “drift”) and another portion of the loss is attributed to water sent down a drain to control the buildup of collected solids (called “blow down”_. These losses in some examples warrant the addition of makeup water that, in some locations, is difficult or expensive to obtain. These types of losses are reduced in the systems described herein.

In one example, blowdown is reduced by designing the systems to reduce the amount of sludge buildup, for example, by designing a collecting basin, trough or the like so that spray fluid, such as water will continually wash the surfaces to reduce the amount of material buildup and physical cleaning necessary. Filtering at least a portion of the recirculated spray fluid will also reduce the accumulated concentration of collected material. Drift is reduced by maintaining a minimum droplet size sprayed into the system that are sufficiently large to minimize (e.g., eliminate or minimize) entrainment and loss in the gas stream moving through the system. Splashing is observed in at least some examples including filters (e.g., fill, mesh or the like) of existing cooling towers. Splashing may, in some examples, generate droplets small enough to be carried away with the gas moving out of the system. The adaptive spray cleaning systems described herein do not use fill and therefore experience minimized splashing. Eliminator plates are optionally used to remove as many drift particles as possible by inertial impaction. However, particles small enough to be carried along by a slow moving air stream are in some examples too small for effective collection by inertial impaction. Optionally, by adding an electrical charge to the spray droplets (e.g., as described herein with electrodes), and an opposite electrical charge to eliminator plates, an additional collection mechanism is used to remove the droplets small enough that are otherwise lost with the exhausting gas, such as cleaned air.

Further, where the spray fluid includes water, water evaporation is reduced by adjusting the droplet chemistry. When pure water droplets are sprayed into air, the air in contact with the droplet surface is saturated (100% relative humidity) at the droplet temperature. When the water is recirculated with no thermal energy addition or removal, its temperature will eventually match (e.g., closely approach) that of the incoming air wet bulb temperature. Thus the air in contact with the droplets is saturated at the incoming air wet bulb temperature. The bulk air that passes through the system then tends toward this saturation condition, 100% relative humidity at the incoming air wet bulb temperature. This occurs by evaporating water from the surface of the droplets into the air stream and thus humidifying and cooling the air. In contrast, if a chemical solution is used rather than pure water, and the air in direct contact with the droplets is at a lower relative humidity than the incoming air, moisture will condense from the air onto the droplets. This causes the air to become more dry and to increase in temperature because the energy of water vapor is higher than the energy of absorbed water. The latent heat of condensation is thereby used to increase the temperature of both the droplets and the surrounding air. Various chemicals are used to accomplish this including salts such as sodium chloride and sodium hydroxide (NaCl and NaOH). By using a chemical solution that has an affinity for water, if the chemical concentration is low (e.g., diluted), some of the water evaporates from the droplets until equilibrium is attained. Conversely, if the concentration is high, water vapor from the air condenses onto the droplets. Accordingly, the concentration automatically tends toward an equilibrium value where no water is evaporated from the droplets or condensed onto them. Accordingly, by including a chemical additive, such as the salts described herein, with the spray fluid water loss by evaporation from the spray droplets is minimized (e.g., eliminated or minimized). In this example, the spray fluid droplets transfer heat to the gas (e.g., a polluted gas such as ambient air) by sensible cooling and not by latent cooling. This changes the ambient heat sink temperature from the ambient wet bulb temperature to the ambient dry bulb temperature. In some examples, there may be an energy penalty (loss) associated with this as the solution temperature that exists the adaptive spray cleaning systems (e.g., for recycling) may be higher than if pure water was used. However, the loss in energy is offset by the conservation of water resources. Accordingly, if the local water resources are considered a higher priority than the change in energy, this is a valuable option. In such an example, the spray fluid as a heat exchanger behaves as a dry heat exchanger but with a significantly higher overall heat transfer coefficient because of the lack of material separating the two fluids (e.g., the spray fluid and the gas) with its inherent thermal resistance and the high surface area of the droplets per unit volume.

In locations where water resources are critical, water is optionally removed from the polluted gas such as ambient air by maintaining the droplet chemistry such that water is absorbed onto the droplets. By removing the excess water by reverse osmosis or some other method (e.g. boiling, evaporation or the like) the chemistry of the droplets (e.g., concentration of one or more hydrophilic additives) is maintained in the absorption mode and water is continuously supplied. The drier air that leaves is optionally supplied to a building or process (e.g., for compressed air, ventilation or the like).

The principle of operation for a wet scrubber is similar in some regards to the adaptive spray cleaning systems described herein. A difference of the adaptive spray cleaning systems over wet scrubbers is the adaptive control provided with the sprayer control systems described herein. The adaptive spray cleaning systems provide dynamic, and in some cases feedback automated, control of performance for particle and gas pollutant removal. According to ASHRAE Guideline 12-2000 and ASHRAE Standard 188-2015, when Aerosol-Generating Misters, Atomizers, Air Washers, Humidifiers, Cooling Towers and Evaporative Condensers are used in a building, the water systems need to be managed and controlled for the risk of Legionellosis associated building water infections. There are two major control methods to disinfect the Legionella Pneumophila: thermal treatment and chemical disinfection (McCoy, 2006; Stout, 2007; Liu et al. 2011). Thermal treatment is conducted by flushing the water outlet with hot water at greater than 60-70 degrees C. for more than 5 minutes and a longer time is suggested (Sidari III et al. 2004). Flushing with hot water is expensive to implement. Chemical disinfection methods are sometimes used including, but not limited to, hyperchlorination in which a free chlorine residual of 1-2 ppm at the water system outlet (i.e. the trough or basin for collecting spraying water in the cooling towers) is maintained or use of chlorine dioxide. Additionally, silver or copper ionization is another approach to control Legionella. Typically, the range of concentration is controlled between 0.2-0.8 and 0.02-0.08 ppm (mg/L) for copper and silver, respectively. However, except for heating the water to 60-70 degrees C. and flushing for more than 5 minutes, the other chemical methods may instigate unwanted chemical reactions in the liquid system if another chemical is added into the system for another purpose, such as NaOH for CO₂ scrubbing. Optionally, the spray fluid described herein includes one or more biocidal additives configured to minimize (e.g., eliminate or minimize) the growth of microorganisms.

In addition to Legionella, other microbes, e.g. pathogenic bacteria, protozoa and viruses can grow in the water system of a cooling tower. Ozonation has been used as one other treatment. Ozonation has been applied in European countries. However, ozonation leaves no residual ozone to control contamination of the water after the process has been completed. Nevertheless, this method is applicable in a water system that contains a water tank for ozonation treatment of the water after certain water running cycles. Ozonation is optionally used with one or more of the adaptive spray cleaning systems described herein to clean the spray fluid.

Membrane filtration also has been found to remove waterborne microbes effectively (Sheffer et al. 2005). Theoretical and experimental studies have been conducted on membrane filtration for different material membranes with different pore sizes, 0.005-0.4 μm, against sub-micron and nano-sized particles (0.002-0.5 μm) with different liquid properties, e.g. different ionic strength, different pH values and charge polarities on the particles (Chen et al. 2015; Lee et al. 2016 a,b; Süß et al. 2015). Results showed that our newly developed model premised on these studies predicts the particle removal efficiency in membrane filters. By using the model, a water recirculation system (e.g., a fluid processor as described herein) is designed with membrane filtration treatment for removal of microbes as well as the particles collected by the sprayer arrays.

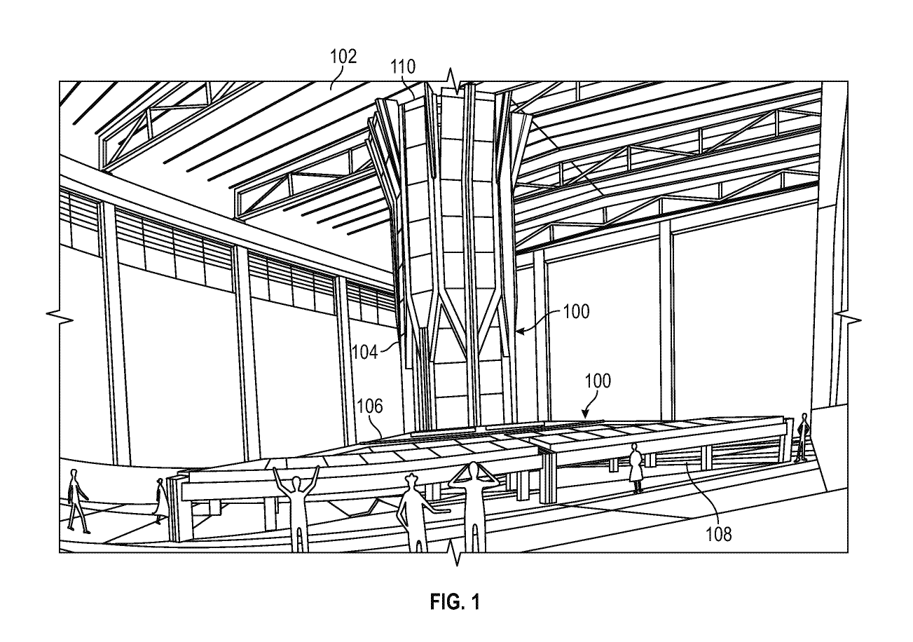

In other examples described herein, the adaptive spray cleaning systems are configured to treat multiple pollutants. For instance, CO₂ is removed simultaneously together with particles with the sprayer arrays. In such an example, the total capital cost for the adaptive spray cleaning system (or wet scrubber including the same) is reduced because a consolidated adaptive spray cleaning system is used to reduce both particulate, CO₂ emissions and optionally other pollutants (for instance with other pollutant treating additives as described herein). For instance, the adaptive spray cleaning systems including one or more sprayer arrays generate liquid sprays including a carbon dioxide capture media (e.g., a capture media soluble in the spray carrier fluid, such as water) to remove the atmospheric CO₂. The large coverage of the array (e.g., volume within a gas tunnel) nozzles spraying carbon dioxide capture media (e.g., NaOH, amines or the like) in a liquid base (droplets) increases the contact interface with the gas, such as air, and effectively captures and removes the CO₂. In an example, TiO₂ is used as the causticization agent for sodium carbonate because the total energy consumption is in some examples 50 percent lower than that of using Ca(OH)₂. FIG. 1 shows one example of an adaptive spray cleaning system 100 within an enclosure 102 including, but not limited to, a building, statue, piece of art, or incorporated into the structure of a building. In another example, the adaptive spray cleaning system 100 as described herein is included as part of another system including, but not limited to, an HVAC system, ventilation system or production gas treatment system (e.g., for the treatment of flue gas, exhaust gas from a power plant or manufacturing assembly or the like). Referring again to FIG. 1, the adaptive spray cleaning system 100 is shown with a gas tunnel 104 extending substantially vertical relative to the remainder of the enclosure 102. As shown, the gas tunnel 104 includes a gas outlet 110 at an elevated position relative to a gas inlet 108. In the example show in FIG. 1, the gas tunnel 104 includes a shroud 106. In one example, the shroud 106 provides lateral positioning of the gas inlet 108 at a position laterally spaced from the remainder of the gas tunnel 104. In one example, the shroud 106 includes translucent or transparent materials that facilitate the transmission of sunlight therethrough to heat a polluted gas such as ambient air or production gas beneath the shroud 106. According to a taper of the shroud 106 the heated gas passively flows up the gas tunnel 104. In another example, the gas tunnel 104 includes an active gas mover, for instance, one or more of a fan, blower or the like.

As will be descried herein, the adaptive spray cleaning system 100 includes a spray assembly having one or more spray nozzle arrays configured to provide a spray of fluid within a stream of polluted gas, for instance, the gas incident at the gas inlet 108 and delivered through the gas tunnel 104 to the gas outlet 110. In one example, the sprayer assembly is provided at a portion of the shroud 106 shown in FIG. 1. For instance, adjacent to the remainder of the gas tunnel 104 extending vertically to the gas outlet 110. In another example, the sprayer assembly is provided within a vertical or horizontal portion of a gas tunnel, such as the gas tunnel 104.

The spray of fluid whether at the shroud 106 or within the remainder of the gas tunnel 104 is directed into the moving gas (e.g., a polluted gas) and the sprayed fluid intercepts particulate matter within the polluted gas and entrains the particulate matter in the spray. The particulate matter drops out of the polluted gas with the spray fluid into a catch basin, collection trough, or the like.

In another example, the spray fluid includes one or more additives configured to interact with one or more pollutants, for instance, gaseous pollutants included in the pollutant gas. The additives catalyze (breakdown) or capture one or more pollutants within the polluted gas. In one example, the broken down pollutants harmlessly exit with the remainder of the cleaned gas. In yet another example, the captured or broken down pollutants are entrained with the spray fluid and collected at a collection basin, collection trough or the like. Optionally, the captured or broken down pollutant components are processed (e.g., collected, recycled, further broken down or the like) at the collection basin or in a processing system in communication with the basin.

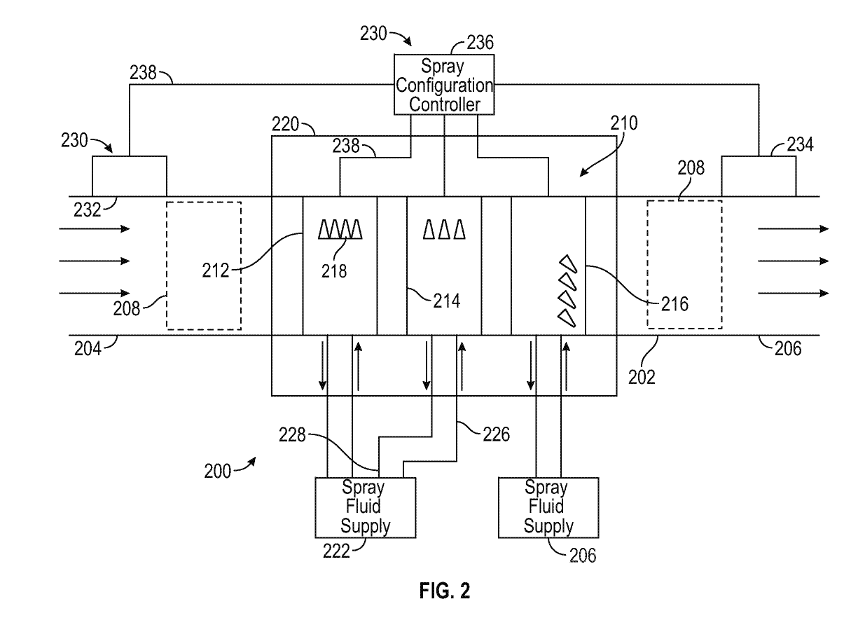

FIG. 2 shows another example of an adaptive spray cleaning system 200 in a schematic representation to facilitate description of each of the components of the example adaptive spray cleaning system 200. The adaptive spray cleaning system 200 as shown in FIG. 2 includes a gas tunnel 202 extending between a gas inlet 204 and a gas outlet 206. As further shown in FIG. 2, in one example, a gas mover 208 is provided at one or more locations within the gas tunnel 202. For instance in the example shown, a gas mover 208 is shown in broken lines proximate one or more of the gas inlet 204 and the gas outlet 206. In another example, the adaptive spray cleaning system 200 includes a passive gas mover. For instance, including one or more of solar heating through translucent (e.g., transparent or translucent) panels of the gas tunnel 202 to facilitate the rising of the polluted gas through the adaptive spray cleaning system 200. In another example, prevailing winds are used to drive the polluted gas through the gas tunnel 202, for instance, in a reciprocal or oscillating fashion between the gas inlet 204 and the gas outlet 206. In an example, for instance with the use of prevailing winds as the gas mover 208, the gas inlet 204 and the gas outlet 206 dynamically shift during operation according to the prevailing wind direction.

In another example, the one or more gas movers 208 include active gas movers such as fans or blowers or both provided inline for instance within the gas tunnel 202. In another example, active gas movers such as fans or blowers 208 are provided outside of the gas tunnel 202, for instance, at a remote position relative to the adaptive spray cleaning system 200. In one example, the adaptive spray cleaning system 200 is provided as a component of another system, for instance, a ventilation system. In some examples, ventilation systems include one or more of blowers, fans, or the like, and accordingly the ventilation system remotely moves the gas into and out of the adaptive spray cleaning system 200.

As further shown in FIG. 2, the adaptive spray cleaning system 200 includes the sprayer assembly 210. In the example shown, the sprayer assembly 210 includes a plurality of sprayer arrays such as the sprayer arrays 212, 214, and 216. In other examples, the adaptive spray cleaning system 200 includes one or more sprayer arrays such as one or more of the sprayer arrays 212-216. Each of the sprayer arrays 212-216 includes at least one spray nozzle 218 configured to provide a spray of fluid from spray fluid supplies 222, 224 (described herein) to the one or more spray nozzles 218. As previously described the sprayed fluid from the one or more spray nozzles 218 intercepts the flowing polluted gas and interacts with the pollutants in the gas to conduct one or more treatment functions including, but not limited to, entrainment of particulate in the pollutant gas or interaction (e.g., catalyzing, capture or the like) of one or more pollutant components within the polluted gas. The entrained particulate from the pollutant and one or more pollutant components (e.g., catalyzed or captured) are in one example collected with the spray fluid supplies (e.g., 222, 224) and processed including, but not limited to, recycled, filtered, stored or the like.

After treatment with the spray assembly 210 the gas exiting the gas outlet 206 includes a minimized concentration (e.g., minimized relative to a concentration at the gas inlet 204) of one or more pollutants. In one example, the polluted gas received at the gas inlet 204 includes ambient air, for instance, collected from an exterior or interior of a building. In another example, the gas received at the gas inlet 204 includes one or more production gases, including but not limited to, boiler flue gases, combustion gases, exhaust gases from manufacturing or industrial processes or the like, that are then treated with the adaptive spray cleaning system 200 as described herein.

As further shown in FIG. 2, each of the sprayer arrays 212, 214, 216 includes exemplary spray nozzles 218 therein. As shown each of the sprayer arrays 212, 214, 216 includes differing spray nozzles 218 to schematically illustrate each of the sprayer arrays 212 includes one or more differing variable spray configuration characteristics such as different nozzle sizes, orientations, positions or the like relative to the other arrays or nozzles. The sprayer arrays 212, 214, 216 are configured to operate independently or cooperatively to accordingly remove or treat a pollutant within the polluted gas stream moving through the gas tunnel 202.

As will be described herein, in one example, the sprayer assembly 210 is in communication with a controller 236 and one or more sensors. The controller 236 and one or more sensors is used to measure one or more pollutant characteristics and then operate the one or more sprayer arrays 212, 214, 216 according to the measurements of the sensors (see such as the inlet and outlet sensors 232, 234). The controlled operation of the one or more sprayer arrays 212, 214, 216 having the variety of spray nozzles 218, nozzle types, sizes, nozzle densities (number of nozzles), nozzle configurations (including angles, orientations, residence times for the spray fluid within the gas tunnel or the like) treats the pollutant gas according to one or more specified treatment configurations stored in a spray configuration controller, such as the controller 236. Additionally, in other examples, the spray fluid used in each or one or more of the sprayer arrays 212, 214, 216 is controlled by the controller 236. The controller 236 adjusts one or more characteristics of the spray fluid. For instance, the controller controls (e.g., changes, regulates or the like) one or more variable spray configuration characteristics including the selection of pollutant treating additives, concentration of pollutant treating additives, the flow rate of the spray fluid, the pressure of the spray fluid or the like, to the one or more sprayer arrays 212, 214, and 216. In an example, the controller 236 is in communication with one or more of the spray fluid supplies 222, 224 shown in FIG. 2 to control the variable spray configuration characteristics available with the spray fluid.

As previously described, the sprayer arrays 212, 214, 216 are in some examples supplied with spray fluids by one or more spray fluid supplies 222, 224. As shown in FIG. 2, in one example, the sprayer arrays 212, 214 are supplied by a common spray fluid supply 222. In another example the sprayer array 216 is separately provided with spray fluid from the spray fluid supply 224. By providing one or more of cooperative supply, independent supply or the like, pollutant treating additives, concentrations of additives or the like, are supplied to each of the sprayer arrays 212, 214, 216 according to the characteristics of a particular pollutant in the polluted gas delivered through the gas tunnel 202. For instance, in one example, where a particular pollutant such as carbon dioxide or the like, is detected at a relatively high concentration (e.g., relative to a median specified value or other threshold) the controller 236 in one example increases the concentration of a capture media (e.g., a pollutant treating additive) in a carrier fluid of the spray fluid supply 222. The spray fluid including the higher concentration of the additive is supplied, for instance, by way of the array input 226 to the corresponding sprayer arrays 212, 214 to treat the polluted gas including the higher concentration of carbon dioxide. The spray fluid is then collected in one example with an array output 228. The array output 228 diverts the used spray fluid, for instance, to a catch basin, collection trough or the like, for cleaning of the used spray fluid, recycling of the used spray fluid, filtering of one or more captured pollutants therein or the like. Conversely, if the measured concentration of a pollutant is low relative to a median value or other threshold the controller 236 optionally decreases the additive concentration in the spray fluid, for instance by dilution of the additive with additional carrier fluid.

As previously described and shown in FIG. 2, in one example the adaptive spray cleaning system 200 includes a sprayer assembly control system 230. In the example shown, the sprayer assembly control system 230 includes the controller 236 in communication with one or more sensors. As shown in FIG. 2, the sensors include one or more of inlet sensors 232 or outlet sensors 234. In one example, the sprayer assembly control system 230 includes sensors 232, 234 at both the gas inlet and outlet 204, 206 to facilitate input and output measurements of one or more pollutant characteristics.

The inlet and outlet sensors 232, 234 each include one or more sensors configured to measure one or more pollutant characteristics of the pollutant gas including, but not limited to, flow rate of the polluted gas, velocity of the polluted gas, temperature of the polluted gas, humidity of the polluted gas, a particulate count (density) of one or more particulate types within the polluted gas, particulate size, chemical composition of the polluted gas (e.g., pollutant identification) or the like. For instance, the inlet and outlet sensors 232, 234 include, but are not limited to, one or more of flow rate sensors, velocity sensors, thermometers, hygrometers, particle counters, particle sizers, photometers, gas analyzers or transmissometers. Measurements taken by one or more of the inlet sensors 232 and outlet sensors 234 are used by the controller 236 to accordingly adjust one or more variable spray configuration characteristics of one or more of the sprayer arrays 212, 214, 216 or the spray fluid supplies 222, 224. The controller 236 is selects and implements the variable spray configuration characteristics through selection and operation of one or more of the sprayer arrays 212, 214, 216 (including the various nozzle sizes, nozzle orientations or the like) or spray fluid supplies 222, 224 to address a variety of pollutant characteristics measured in the polluted gas moving through the gas tunnel 202.

In one example, the spray configuration controller 236 operates at least one of the sprayer arrays 212, 214, 216 according to the concentration of one or more pollutants within the polluted gas moving between the gas inlet 204 and the gas outlet (measured with one or more of the inlet and outlet sensors 232, 234). For instance, where a high concentration of a particulate or other pollutant within the polluted is detected, a plurality of the sprayer arrays 212, 214 each including one or more spray nozzles is operated to accordingly address the rise in the measured pollutant characteristics in the polluted gas. In another example, where increased residence time of the spray fluid is specified relative to a particular detected pollutant for instance, to ensure treatment such as capture or catalyzing of the pollutant with an additive, another nozzle array such as the sprayer array 216 is operated having angled nozzles 218 that provide upward and downward (through gravity) travel of the spray fluid.

In another example, where high concentration of a pollutant is detected for instance by one or more of the inlet sensors 232 or the outlet sensors 234, the sprayer array 212, for instance, including the smaller spray nozzles 218 is operated to provide a finer droplet size for the spray fluid that interacts more fully with the higher concentration pollutant within the polluted gas (e.g., provides enhanced entrainment, capture or catalyzing). Where the concentration of the pollutant is relatively low (for instance, relative to the high concentration or another threshold) the larger nozzles 218 of the nozzle array 213 are in one example operated by the controller 236 to accordingly provide larger droplets and use less resources (relative the sprayer array 212) while at the same time treating the lower concentration of the pollutant in the polluted gas.

In some examples, the controller 236 is configured to operate one or more of the spray fluid supplies 222, 224. As described herein, in one example, controller 236 changes the concentration of one or more pollutant treating additives of the spray fluid, for instance by adding a measured quantity of the additive to the spray fluid supply 222, 224 or diluting the additive (e.g., with the addition of carrier fluid, such as water) to address variations in concentration of one or more pollutants in the polluted gas. In another example, the controller 236 operates one or more of the spray fluids supply 222, 224 to provide a specified flow of the spray fluid to one or more of the sprayer arrays 212, 214, 216 at a specified flow rate, pressure, concentration, composition or the like. The sprayer arrays 212, 214, 216 as well as the spray fluid supplies 222, 224 are in one example cooperatively operated by the controller 236 to selectively provide (e.g., control) one or more variable spray configuration characteristics including, but not limited to, nozzle orientation, nozzle density (number), one or a plurality of nozzle arrays (with corresponding variation in the number of nozzles), droplet size of the spray fluid, as well as changes in one or more characteristics of the spray fluid (also included as examples of variable spray configuration characteristics) including, but not limited to, additive concentration in the spray fluid, additive composition (e.g., one or more additives or no additives) spray fluid flow rate, pressure or the like.

The adaptive spray cleaning system 200 described herein (including the other example systems herein) is able to dynamically adjust to one or variations in pollutant characteristics in a polluted gas (e.g., composition of pollutants in the gas, concentrations of pollutants, particulate size, density or the like) that are identified with the one or more sensors such as the inlet or outlet sensors 232, 234. In one control configuration, the one or more inlet and the outlet sensors 232, 234 communicate with the controller 236 and form a feedback control system that facilitates the operation of one or more of the sprayer arrays 212, 214, 216 or the spray fluid supplies 222, 224 to responsively treat the gas for a variety of pollutants and pollutant characteristics.

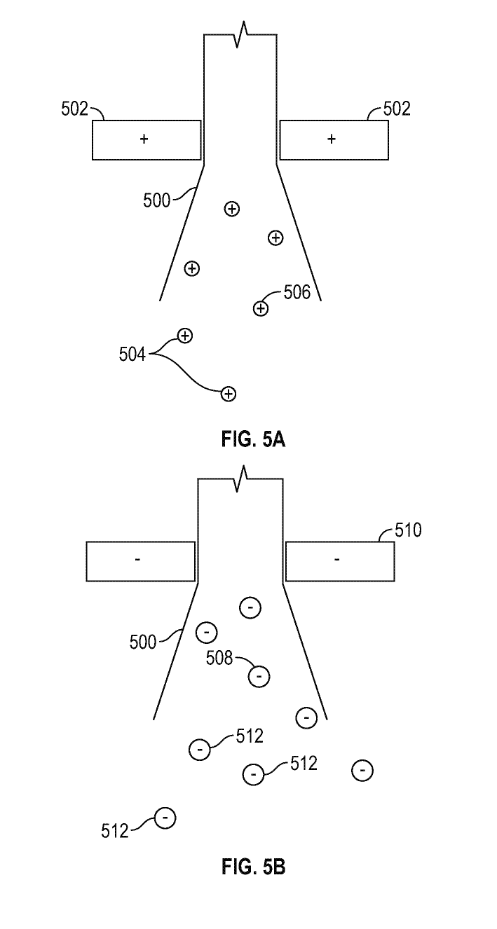

As shown in FIG. 2, the controller 236 is in one example in communication with each of the nozzle or arrays, 212, 214, 216 and the sensors 232, 234 with one or more controller interfaces 238. In some example, the controller interfaces 238 include, but not is limited to, wireless connections, wired connections, optical connections, radio connections or the like. Additionally, the controller 236 in another example, communicates with each of the spray fluid supplies 222, 224 to regulate (e.g., control) one or more of valves, pumps, or the like configured to operate each of the spray fluid supplies 222, 224 (as shown herein for instance in FIG. 6). The controller 236 interacts with the spray fluid supplies 222, 224 for instance, with controller interfaces like the interfaces 238, including, but not limited to, wired connections, wireless connections, optical connections, radio connections or the like.

Although FIG. 2 shows a system with the controller 236 in communication with one or more inlet and outlet sensors 232, 234, in another example the controller 236 uses an open loop control configuration. For instance, the controller 236 controls one or more of the sprayer arrays 212, 214, 216 or the spray fluid supplies 222, 224 according to one or more open loop controls including, but not limited to, known seasonal variations in pollutants, daily variation in pollutants and concentrations of pollutants (e.g., near to a rush hour, over busy holidays or the like). Controller 236 this example automatically regulates one or more of the sprayer arrays 212, 214, 216 or the spray fluid supplies 222, 224 according to one or more open loop control configurations. For instance in the summer with increased driving in a metropolitan area the controller 236 operates the sprayer assembly 210 according to historical averages (including seasonal increases) due to increased summer driving in area. Accordingly, one or more of the sprayer arrays 212, 214, 216 is operated in combination optionally with an increased concentration of additives supplied by the spray fluid supplies 222, 224. Conversely, in the winter when the frequency of driving decreases one or more of the sprayer arrays 212, 214, 216 are shut down and additives within the spray fluid from the supplies 222, 224 are decreased to account for the decrease in pollutant concentration in the ambient air cycled through the gas tunnel 202.

Similarly in industrial environments (e.g., power plants, manufacturing plants or campuses or the like) and during spikes in industrial operations a predictable rise in pollutants and polluted gas is known or estimated and used to automatically operate one or more of the sprayer arrays 212, 214, 216 or the spray fluid supplies 222, 224 to treat the increased generation of pollutants. As described herein, reference is made to the control of one or more of the sprayer arrays 212, 214, 216 of the spray fluid supplies 222, 224. The operation of one or more of these arrays or spray fluid supplies is not mutually exclusive. Instead, the controller 236 is configured to operate each of the sprayer arrays 212, 214, 216 and the spray fluid supplies 222, 224 independently, cooperatively or the like.

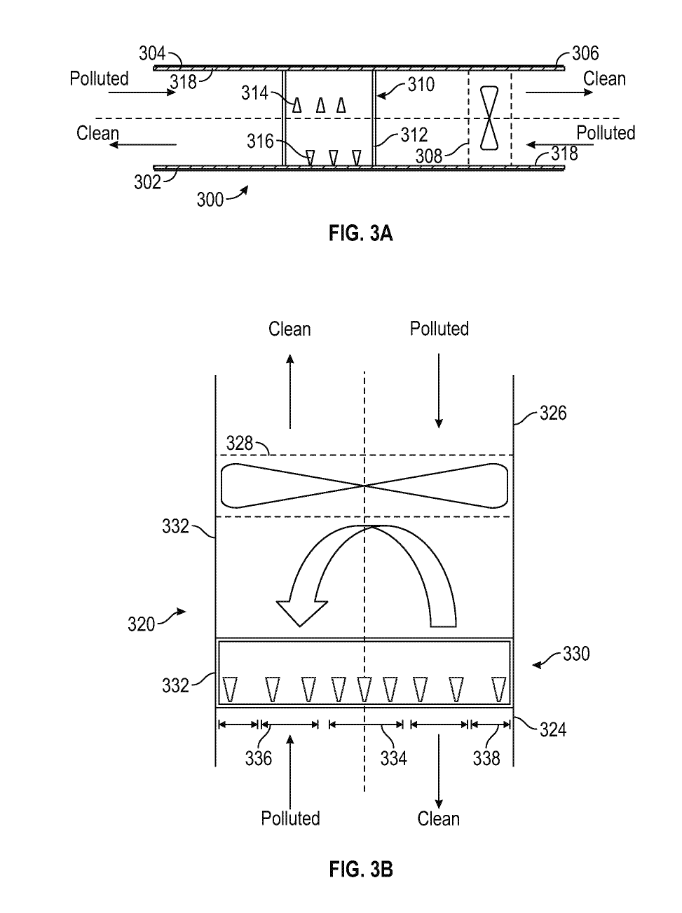

FIGS. 3A and 3B show two examples of adaptive spray cleaning systems 300, 320. The adaptive spray cleaning system 300 shown in FIG. 3A is in an exemplary horizontal configuration while the adaptive spray cleaning system 320 shown in FIG. 3B is in a vertical configuration.

Referring first to FIG. 3A, the adaptive spray cleaning system 300 includes similar components to the previously described cleaning system 200 provided herein. For instance the cleaning system 300 includes a gas tunnel 302 extending from the left to the right. Further, the gas tunnel 302 includes a gas inlet 304 and a gas outlet 306. As further shown in FIG. 3A, in one example the orientation of the gas inlet and outlets are switched for instanced where the gas mover 308 operates in an opposed direction. The opposed directions of operation is shown for instance by the upper and lower pairs of arrows separated by the bifurcating dashed line in FIG. 3A. For instance, polluted gas is received at the gas inlet 304, treated within the sprayer assembly 310 including the sprayer array 312 and then exhausted from the adaptive spray cleaning system 300 at the gas outlet 306. In this example the gas mover 308 for instance an active gas mover such as a fan, blower or the system at a negative pressure and draws the polluted gas into the gas tunnel 302 and then exhausts the treated (e.g., cleaned) gas from the gas outlet 306.

In another example the gas mover 308 is used in a positive pressure system. For instance, the polluted gas is received (as shown below the bifurcating dashed line) at the gas inlet 306 (previously used as an outlet). The gas mover 308 moves the polluted gas into the sprayer assembly 310 including at least one sprayer array such as the sprayer array 312 where the polluted gas is treated (e.g., by entrainment of one or more particulates, reaction or capture of one or more pollutant components or the like) and then exhausted through the gas outlet 304 (previously used as an inlet).

As further shown in FIG. 3A, the adaptive spray cleaning system 300 includes at least one sprayer array 312. In the example shown the sprayer array 312 includes a plurality of spray nozzles 314, 316. The spray nozzles 314 are provided at an upper portion of the sprayer array 312 while the spray nozzles 316 are provided at a lower portion and directed upward. As described herein a plurality of sprayer array configurations are provided in multiple figures and are readily adaptable (e.g., are modular) and used in one or more adaptive spray cleaning systems, such as the system 300, 200 (and other example systems described herein).

In another example, the adaptive spray cleaning systems described herein include a plurality of nozzle arrays providing a variety of spray configuration characteristics that are variably operated, selected or the like whether alone or in combination to provide customized and specified treatment (for instance with the controller 236) of a pollutant gas received within the adaptive spray cleaning system. As previously described herein in one example the adaptive spray cleaning system 200 shown for instance in FIG. 2 includes a controller 236 as part of a sprayer assembly control system 230. The controller 236 operates one or more of a plurality of sprayer arrays 212, 214, 216 as well as any of the sprayer arrays described herein, for instance arrays shown in FIGS. 3A, B and other Figures herein. Additionally, the controller 236 in another example operates one or more spray fluid supplies 222, 224 to accordingly provide a specified configuration of spray fluid (e.g., also examples of variable spray configuration characteristics) to each of the sprayer arrays. Returning to FIG. 3A the sprayer array 312 shown therein includes cross tunnel oriented spray nozzles 314, 316. That is the spray nozzles 314, 316 are directed across the gas tunnel 302 to accordingly provide sprays of fluid in an angled direction (e.g., orthogonal, angle relative to horizontal, vertical or the like) relative to the direction of the moving polluted gas. In one example, the sprays of fluid impact one or more of particulate and pollutant components in the polluted gas to treat pollutants by entraining particulate and capturing or reacting (breaking down) with pollutant components.

As further shown in FIG. 3A, the spray nozzles 316 of the sprayer array 312 are in one example oriented in a vertical or upward angled configuration configured to provide a spray of fluid opposed to the direction of gravity. In such an example, the spray fluid is directed upwardly (whether orthogonally angled or the like). The spray of fluid from the sprays nozzles 316 relative to the spray nozzles 314 has an increased residence time within the gas tunnel 302 as the spray fluid travels up and down within the gas tunnel 302. Accordingly, polluted has increased residence time within the spray fluid as the fluid travels upwardly and downwardly (e.g., passes through the polluted gas twice). In another example, the increased residence time increases the quantity of spray droplets in the gas tunnel 302 at any time as droplets are present in both the upward and downward moving directions. The increased residence time of the spray fluid enhances treatment, including but not limited to, entrainment of particulate and capture or catalyzing of one or more polluted gas components with corresponding pollutant treating additives or the like in the spray fluid.

In another example the gas tunnel 302 includes a catalyst substrate 318 for instance provided along one or more surfaces of the gas tunnel 302 such as tunnel walls. In another example the gas tunnel 302 includes a substrate, vent louver or the like provided with a catalyst substrate 318 thereon. In one example the catalyst substrate 318 is provided on one or more features such as a louver, screen or the like that is readily removed and replaced within the gas tunnel 302. The catalyst substrate 318 in one example is a substrate configured to react and break down one or more pollutant components within the polluted gas received in the gas tunnel 302.

The catalyst substrate 318 includes, but is not limited to one or more of titanium dioxide, a photo catalyst or a nanomaterial configured to break down one or more pollutant components within the polluted gas. The movements of the gas within the gas tunnel 302 for instance passively or actively by way of the gas mover 308 causes the polluted gas to flow along one or more surfaces of the gas tunnel 302 (e.g., gas tunnel walls, tunnel screen, tunnel media or the like) for instance shown by the upper and lower surfaces in FIG. 3A. Pollutant components of the polluted gas interact with the catalyst substrate 318 as it flows through the gas tunnel 302. Optionally the gas tunnel 302 includes one or more of fins, knurling, posts, passages, screens, grooves, ridges or the like configured to increase the surface area of the gas tunnel 302 and facilitate turbulence in the gas flow through the gas tunnel 302. The increased surface area, turbulence or the like enhances interaction between the polluted gas and the catalyst substrate 318.

Optionally, the catalyst substrate 318 includes a photo-catalyst, such as titanium dioxide, that is catalyzed when exposed to light. As previously described, in one example a portion of the gas tunnel (e.g., a shroud or the like) is translucent (e.g., transparent or translucent) to facilitate the reception sunlight and catalyzing of the catalyst substrate 318. In one example, the gas tunnel 302 walls shown in FIG. 3A are translucent and the catalyst substrate 318 is catalyzed as sunlight is transmitted through the walls.

FIG. 3B shows another example of an adaptive spray cleaning system 320 oriented vertically. For instance, the adaptive spray cleaning system 320 includes a vertical gas tunnel 322 having least a portion of the tunnel in a vertical orientation. The gas tunnel 322 includes a gas inlet 324 and a gas outlet 326 that are optionally used (e.g., switched) as either of the opposed outlet or inlet. Stated another way, the gas mover 328 such as a fan or blower moves the polluted gas in an upward or downward fashion depending on the specifications for the adaptive spray cleaning system 320.

As further shown in FIG. 3B, the sprayer assembly 330 in this example includes at least one sprayer array, such as the sprayer array 332. As shown, the nozzles of the sprayer array 332 are directed in an upward fashion (for instance upwardly relatively to the gas tunnel 322). In a similar manner to the spray nozzles 316 shown in FIG. 3A the spray nozzles of the sprayer array 332 are angled (e.g., in this example vertically, in other examples at an upward angle relative to horizontal) vertically to increase the residence time of the sprayer fluid. As shown with the schematic arrow provided in FIG. 3B the spray fluid is sprayed upwardly within the gas tunnel 322 and subsequently falls back (for instance through the sprayer array 332). The spray fluid (e.g., with particulate, pollutant components or the like therein) is collected, for instance at a lower portion of the gas tunnel 322, in a collection basin, trough, tubes, reservoir or the like.

As further shown in FIG. 3B the sprayer array 332 in one example includes a plurality of arrays for instance first, second and third nozzle arrays 334, 336, 338. In one example the sprayer arrays are provided in a composite assembly at a localized position within the gas tunnel 322. In such an example the arrays 334, 336, 338 provide one or more zones of coverage within the overall gas tunnel 322. For instance as shown in FIG. 3B, a first nozzle array 334 is provided near the center of the gas tunnel 322. Conversely, second and third arrays 336, 338 are provided at positions gradually spaced from the first nozzle array 334 toward the edges of the gas tunnel 322.

In one example the first nozzle array 334 includes a higher density of nozzles (for instance a larger count of overall nozzles) relative to the second or third nozzle arrays 336, 338. In another example, the higher density of the first nozzle array 334 includes a larger number of nozzles than the second nozzle array 336 or the third nozzle array 338. Optionally the higher density of nozzles in the first nozzle array 334 equates to a smaller number of nozzles (relative to the other arrays) that are distributed in a tight arrangement in a portion of the tunnel. For instance, there are fewer nozzles in the first nozzle array 334 but the nozzles are densely packed relative to the more numerous nozzles of the second or third arrays. As further shown in FIG. 3B the second nozzle array 336 and the third nozzle array 338 have progressively fewer nozzles or nozzles in a less packed arrangement relative to the first nozzle array 334.

The variations in nozzle density between each of the first, second and third nozzle arrays 334, 336, 338 is in one example varied according to the velocity profile of the polluted gas through the gas tunnel 322. For instance, the velocity profile for the polluted gas is greater toward the middle of the gas tunnel 322 and relatively less toward the periphery of the gas tunnel 322 for instance along the walls of the gas tunnel 322. Because of the higher velocity of the polluted gas through the middle portion of the gas tunnel 322 a higher density of nozzles is provided in the first nozzle array 334 to better treat a relatively larger flow of the polluted gas at that corresponding location. As the velocity of the gas and the corresponding flow rate decreases toward the periphery of the gas tunnel 322 the density of the nozzles is in one example decreased as shown by the second and third nozzle arrays 336, 338.

In some examples each of the first, second and third nozzle arrays 334, 336, 338 are operated at the same time. In another example, one or more of the first, second and third nozzle arrays 334, 338, 336 are operated independently. For instance one or more of the first or second nozzle arrays 334, 336 is operated alone or together while the third nozzle array 338 is not operated (e.g., at a low polluted gas flow rate, low pollutant concentration or the like). In another example, a single array, for instance the first nozzle array 334, is operated by itself where a pollutant characteristic (e.g., concentration, particulate count or size, or the like) is less severe than those warranting the cooperative use of the second or third nozzle arrays 336, 338.

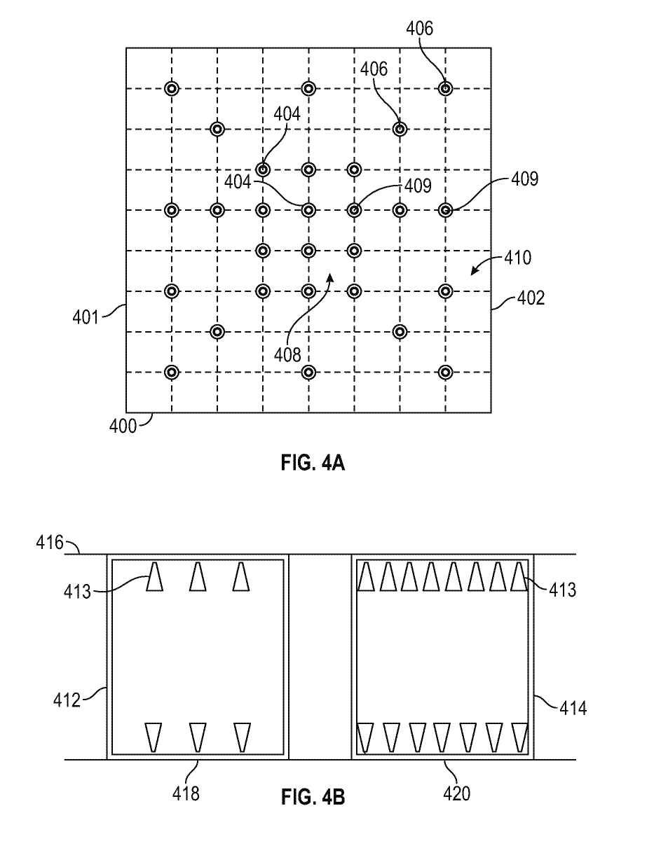

FIG. 4A shows one example of a composite sprayer array 400 similar in at least some regards to the sprayer array 332 shown in FIG. 3B. The example array shown in FIG. 4A is provided in a plan view to illustrate a plurality of nozzles within the composite sprayer array 400. As shown in FIG. 4A the composite sprayer array 400 includes a first sprayer array 404 having an increased density of spray nozzles 409 and a second sprayer array 406 having a decreased density of spray nozzles 409. The composite sprayer array 400 is in one example positioned in a single location within the gas tunnel 402 with each of the first and second sprayer arrays 404, 406 positioned at the same linear location along the length of the gas tunnel.

As shown in FIG. 4A, the gas tunnel wall 402 encircles each of the first and second sprayer arrays 404, 406. In another example, the composite sprayer array 400 provides an example of a plurality of sprayer arrays, such as first and second sprayer arrays 404, 406, that are located at substantially the same position along the gas tunnel 401. As described herein other examples of sprayer arrays are positioned at different locations, for instance staggered or staged locations within a gas tunnel, to provide a plurality of nozzle arrays at one location or at a plurality of locations along the gas tunnel 401.

Referring again to FIG. 4A, each of the first and second sprayer arrays 404, 406 show the spray nozzles 409 in differing densities. For instance, the first sprayer array 404 includes spray nozzles 409 in a relatively packed configuration toward an interior zone 408 of the gas tunnel 401 (e.g., toward a center of the tunnel or remote from the walls 402). As previously described, in one example the velocity (and flow) profile of the polluted gas within the gas tunnel is greatest toward the interior zone 408 of the gas tunnel. Accordingly, a higher density of spray nozzles 409 is provided in the first sprayer array 404 to treat the relatively larger flow rate of the pollutant gas through the interior zone 408. Conversely, in another example the second sprayer array 406 includes a smaller second density of spray nozzles 409 relative to the first sprayer array 404. As shown in FIG. 4A, the spray nozzles 409 are provided in a more distributed fashion within the exterior zone 410 of the gas tunnel 401. The spray nozzles 409 of the second sprayer array 406 are nearer to the gas tunnel wall 402 and relatively remotely relative to the interior zone 408. The decreased velocity (and flow rate) profile of the polluted gas near to the gas tunnel wall 402 allows for the inclusion of less dense spray nozzles 409 (e.g., at a lesser density relative to the first sprayer array 404) to address the decreased flow of the polluted gas relative to the polluted gas otherwise through the interior zone 408. Although the spray nozzles 409 are shown in a substantially identical configuration (by the schematic circles provided in FIG. 4A) in another example the spray nozzles 409 vary between the first and second sprayer arrays 404, 406. For instance the nozzles of each of the sprayer arrays 404, 406 differs in size (with different droplet sizes, flow rates or the like), differs in direction or orientation to provide spray fluid in one or more differing directions (as described herein) or the like.

FIG. 4B shows another example of a plurality of sprayer arrays, for instance first and second sprayer arrays 412, 414 having different densities. As shown in FIG. 4B, the gas tunnel 416 includes the first and second sprayer arrays 412, 414 at differing locations first and second locations 418, 420. In contrast to the first and second arrays 404, 406 of FIG. 4A, the first and second sprayer arrays 412, 414 are positioned at the differing locations and accordingly provide a staged application of one or more sprays to the pollutant gas within the gas tunnel 416.

The first sprayer array 412 provides its spray nozzles 413 in a less dense (e.g., one or more of less numerous or less densely arranged) configuration relative to the spray nozzles 413 of the second sprayer array 414. The first sprayer array 412 includes spray nozzles 413 at a decreased density relative to the density of the spray nozzles of the second sprayer array 414. Conversely, the second sprayer array 414 includes its spray nozzles 413 at a higher density (e.g., one or more of more numerous or more densely arranged) relative to those in the first sprayer array 412. In one example the first and second sprayer arrays 412, 414 are selectively operated according to various pollutant characteristics. For instance with a high pollutant concentration in one example the second sprayer array 414 is operated by itself or in combination with the first sprayer array 412 to enhance overall entrainment or catalyzing of pollutants within the pollutant gas. In another example for instance with a pollutant gas having a lower concentration of pollutants the first sprayer array 412 having a decreased density of spray nozzles 413 is operated by itself to accordingly conserve spray fluid and other resources of the adaptive spray cleaning system while at the same time treating the polluted gas having the lower pollutant concentration.

FIG. 4C shows another example of the sprayer assembly 422 including a plurality of sprayer arrays provided in staggered or staged positions relative to each other. Although FIG. 4C shows a plurality of sprayer arrays 426, 428, 430 at differing linear locations within the gas tunnel 424 in another example the sprayer arrays are consolidated for instance into an overall composite sprayer array including each of the sprayer arrays therein and located at a single location within the tunnel.

Referring again to FIG. 4C, as shown the sprayer assembly 422 includes multiple sprayer arrays each having different examples of spray configuration characteristics. As previously described herein, in one example the adaptive spray cleaning system 200 includes a controller 236 configured to operate one or more sprayer arrays. The controller 236 is optionally configured to operate any of the example sprayer arrays described herein including the sprayer arrays 426, 428, 430 together or separately according to one or more inputs including for instance pollutant characteristic measurements.

Referring first to the sprayer arrays 426 and 430 shown in the gas tunnel 424 each of the spray nozzles 432 and 436 of the respective sprayer arrays 426, 430 are directed along the gas tunnel 424 (e.g. substantially parallel to the direction of pollutant gas flow within the gas tunnel). In the first example with the spray nozzles 436 of the sprayer array 430 the spray fluid is directed upwardly. After the spray fluid is delivered upwardly a specified distance (corresponding to the pressure of the spray fluid at delivery from the spray nozzles 436) the spray fluid turns (e.g., see the schematic arrow) and falls within the gas tunnel 424. The increased residence time of the spray fluid according to the upward and downward movement within the gas tunnel 424 allows for enhanced treatment of the polluted gas including, but not limited to, entrainment of particulate, or reaction or capture of one or more pollutant components with the spray fluid.

In a similar manner the sprayer array 426 including the spray nozzles 432 is provided at a relatively elevated location of the gas tunnel 432 relative to the sprayer arrays 428, 430. The spray nozzles 432 are configured to direct the spray fluid in a downward fashion for instance parallel to the pollutant gas moving within the gas tunnel 424. The position of the sprayer array 426 (e.g., at the elevated location relative to the sprayer arrays) facilitates the increased residence time of the spray fluid from the spray nozzles 432. Accordingly, in one example the spray fluid is delivered (e.g., under low pressure as an upward pressurized spray is not used) from the spray nozzles 432 and then relies on gravity and the length of the gas tunnel 424 to increase residence time within the gas tunnel 424. Each of the sprayer arrays 426, 430 provide spray configuration characteristics including increased residence time, differing orientations of the spray nozzles 432, 436 and the like. By increasing the residence time of the spray fluid treatment including one or more of entrainment, reaction of the spray fluid with pollutants, or capture of pollutants is thereby enhanced.

As further shown in FIG. 4C another sprayer array 428 is provided at another in-line location within the gas tunnel 424. As shown, the spray nozzles 434 of the sprayer array 428 are oriented in a helical fashion within the gas tunnel 424. For instance, the solidly illustrated spray nozzles 434 are directed in an ascending from the right to the left while the spray nozzles 434 shown in the background (e.g., along a back wall of the gas tunnel) with dashed lines direct the spray fluid in an ascending configuration ascending from the left to the right. Accordingly, in one example the spray nozzles 434 of the sprayer array 428 provides a cyclonic or helical configuration of the spray fluid to accordingly move the spray fluid in a helical or spiral manner within the gas tunnel 424 to increase residence time (e.g., to enhance treatment of the polluted gas as described herein) Each of the sprayer arrays 426, 428, 430 thereby illustrates multiple examples of spray configuration characteristic including the orientation of the spray nozzles, direction within the gas tunnel (for instance opposed to, in the same direction of the polluted gas, at an angle or the like).

FIG. 4D shows another example of a system oriented in a horizontal manner. As shown, the sprayer assembly 438 includes a plurality of sprayer arrays 442, 444. In this example the sprayer arrays 442, 444 are provided at separate locations within the gas tunnel 440 (e.g., a multi-stage configuration). In another example, and as previously shown herein the sprayer arrays 442, 444 are consolidated into a composite sprayer array including the first and second sprayer arrays as shown for instance in FIG. 4A having first and second sprayer arrays 404, 406 at substantially the same in-line location within the gas tunnel 401.

As further shown in FIG. 4D each of the sprayer arrays 442, 444 include differing spray nozzles 446, 448. In one example the spray nozzles 446, 448 include spray nozzles configured to dispense respectively large or small droplets according the specifications of the sprayer assembly 438 (e.g., according to control provided by the controller 236 for instance shown in FIG. 2). The differing nozzles are used by the respective sprayer arrays 442, 444 in one example based on differing conditions of the pollutant received within the gas tunnel 440. As shown in FIG. 4D, the sprayer array 442 is in one example configured with the spray nozzles 446 to dispense spray droplets 450 having a larger diameter or size relative to the spray droplets 452 made with the spray nozzles 448 of the sprayer array 444.

In one example smaller spray droplets, such as the spray droplets 452 produced by the sprayer array 444 are used in one example with high pollutant concentrations to accordingly enhance treatment (e.g., entrainment and reaction or capture) of the pollutants in the higher pollutant concentrated polluted gas. Conversely, in another example larger spray droplets 450 for instance those shown with the sprayer array 442 are used with polluted gases having a decreased pollutant concentration relative to that used with the sprayer array 444. The larger spray droplets 450 allow for more efficient (e.g., decreased flow rate of spray fluid) operation of the sprayer assembly 438 while at the same time also treating the pollutants in the in the pollutant gas have the lower pollutant concentration. In another example, both of the sprayer arrays 442, 444 are operated in other examples, for instance with extremely high pollutant concentrations, and thereby work cooperatively to decrease the high concentration of pollutants within the polluted gas.

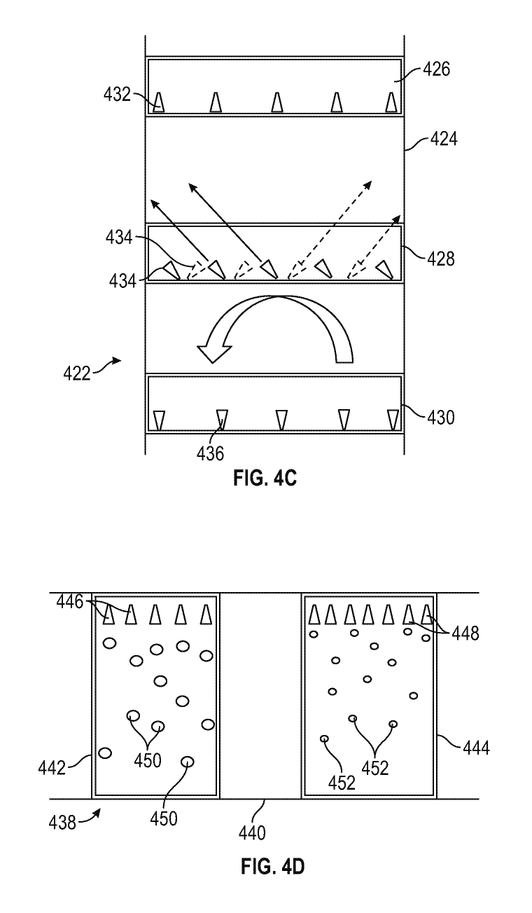

FIGS. 5A and 5B show examples of spray nozzles 500, 508 configured to provide one or more spray droplets 504, 512 having differing droplet sizes such as respective first and second droplet sizes 506, 508. The droplet sizes 506, 508 shown in FIGS. 5A, B and previously shown in another example in FIG. 4D are exaggerated for illustrative purposes.

Referring first to FIG. 5A, the spray nozzle 500 is configured to provide a smaller first droplet size 506 relative to the second droplet size 508 of the spray nozzle 508. For instance, in one example the spray nozzle 500 has a smaller opening nozzle configuration relative to the corresponding configuration of the spray nozzle 508. Accordingly, the spray fluid when received at the spray nozzle 500 is dispensed as smaller droplets in a finer spray relative to that otherwise dispensed by the spray nozzle 508. The spray nozzle 500 shown in FIG. 5A is in another example included in a nozzle array such as the second sprayer array 414 of the sprayer assembly shown in FIG. 4B. Conversely, the larger spray nozzle 508 is in one example included in another sprayer array such as the first sprayer array 412 of the sprayer assembly shown in FIG. 4B.

Referring now to FIG. 5B the spray nozzle 508 is larger than the spray nozzle 500. The larger spray nozzle 508 and the spray nozzle 500 are in one example exaggerated to show the difference in the spray nozzles 500, 508 and to accordingly show the difference in droplet sizes such as the first and second droplet sizes 506, 508. As shown, the second droplet size 508 is relatively larger compared to the first droplet size 506 and accordingly provides a (more coarse) sprayed mist having a larger overall droplet size relative to the spray fluid dispensed by the spray nozzle 500.

As further shown in FIGS. 5A and 5B, in one example one or more of the spray nozzles described herein such as the spray nozzles 500, 508 include one or more electrostatic electrodes 502, 510. Referring first to FIG. 5A, in one example one or more electrodes such as electrostatic electrodes 502 are provided at one or more locations along the spray nozzle 500 for instance adjacent to a metallic or other conductive wall of the spray nozzle 500. The electrostatic electrodes 502 are in one example provided with a net electric charge to accordingly provide a corresponding net electric charge to the spray droplets 504.

In one example the spray droplets 504 are provided with the electrostatic charge, such as the illustrated positive charge, to accordingly interact with and couple with one or more pollutants or pollutant components having a net negative electrical charge. Accordingly, the charged spray droplets 504 readily couple with these components and in one example enhance the entrainment of the pollutant for instance pollutant particulate or the like within the spray fluid. In one example one or more of the sprayer arrays described herein includes one or more of the electrostatic electrodes 502, 510 (positive, negative or both) and are selectively operated to accordingly provide a desired net charge to the corresponding droplets to interact with one or more differing types of pollutants (having a net opposed and thereby attractive charge to the droplets) within a polluted gas.

As further shown in FIG. 5B, the spray nozzle 508 includes another example of electrostatic electrodes 510 in this example having a net negative charge. The charged spray droplets 512 have a corresponding negative charge and are configured in one example to readily couple with one or more pollutant components, for instance ions having a net positive charge. Treatment of the polluted gas, including, but not limited to, entrainment or interaction of the spray fluid with one or more pollutant components is thereby enhanced according to the opposed (and attractive) charges between the charged spray droplet 512 and the one or more pollutant components.

FIG. 6 shows one example of a spray fluid supply 600. The spray fluid supply 600, in one example, corresponds to one or more of the spray fluid supplies 222, 224 (shown in FIG. 2). The example spray fluid supply 600 includes one or more reservoirs including, but not limited to, a spray fluid sump 602, carrier fluid supply 604 and an additive supply 606. As will be described herein, the spray fluid supply 600 uses one or more of the associated reservoirs to provide an additive, for instance, an additive mixed with a carrier fluid to one or more sprayer arrays such as the sprayer arrays 212, 214, 216 shown in FIG. 2 as well as any of the other sprayer arrays described herein.

Referring again to FIG. 6, the spray fluid supply 602 is shown with an array output 608 (e.g., a spray fluid return, drain or the like) extending into the spray fluid sump 602. In one example, the array output 608 corresponds to one or more of the array outputs 228 shown in FIG. 2 and associated with the corresponding spray fluid supplies 222, 224. The array output 608 returns spray fluid including one or more of entrained particulate, captured pollutants, catalyzed pollutants or the like to the spray fluid sump 602. In one example, the spray fluid sump 602 includes a fluid processor 610 configured to recycle the spray fluid, for instance, by way of one or more of filtering, screening, cleaning of the spray fluid, reacting of components of the spray fluid (such as collected pollutant components) or the like. The fluid processor 610, in one example, removes the pollutant components from the spray fluid and accordingly provides a cleaned or recycled flow of the spray fluid to the remainder of the spray fluid supply 600, for instance, by way of the recycled fluid input 610 and associated pump 616 shown in FIG. 6. The inline pump 616 and the recycled fluid input 610 provide the recycled spray fluid to one or more sprayer arrays, for instance, sprayer arrays 212, 214, 216 shown in FIG. 2. As shown in FIG. 6, the recycled input 610 (and other inputs 612, 614) is in communication with a control valve 620 that provides a regulated flow of the spray fluid to the sprayer arrays, for instance, by way of control provided by the controller 236 of the sprayer assembly control system 230 (shown previously in FIG. 2 and described herein).

In another example, the spray fluid supply 600 includes a carrier fluid supply 604 and an additive supply 606. The carrier fluid supply 604 and the additive supply 606 are used in combination, for instance, to initiate operation of one or more of the sprayer arrays 212, 214, 216. For instance, the carrier fluid provided by the carrier fluid supply 604 and the additive provided in the additive supply 606 are mixed at the specified concentration at a confluence upstream from the control valve 620. In one example, one or more of the pumps 616 associated with the additive and carrier fluid supplies 606, 604 are operated in combination to accordingly ensure an accurate mixture and corresponding concentration of the additive with the carrier fluid 604. The mixed spray fluid is delivered through the control valve 620 (in another example a pump in communication with a storage vessel including a stored volume of the spray fluid having the desired concentration) to one or more sprayer arrays.

In another example, the carrier fluid supply 604 and the additive supply 606 are used in combination with the spray fluid 602 to add make up spray fluid to the recycled spray fluid from the spray fluid sump 602. In still another example, the additive and carrier fluid supply 606, 604 are used in combination to regulate the concentration of the additive in the spray fluid (e.g., one or more of maintenance, increasing or decreasing concentration). In one example, the controller 236 of the sprayer assembly control system 230 cooperatively operates each of the pumps 616, valves or the like in one or more of the additive input 614, the carrier fluid input 612 and the recycled spray fluid input 610 to selectively mix the additive from the additive supply 606, the carrier fluid from the carrier fluid supply 604 and the recycled spray fluid from the spray fluid sump 602. Accordingly, the controller 236 selectively adds carrier fluid or additive to the recycled spray fluid from the spray fluid sump 602 to control the concentration of the spray fluid, for instance, by adding additive through the additive input 614 or selectively adding carrier fluid 604 to the spray fluid to dilute the spray fluid. In an example, one or more of the spray fluid supply 600 or another portion of the adaptive spray cleaning system described herein (e.g., the systems 200, 300 or the like) includes one or more sensors configured to measure the concentration of additives, pollutants or the like in the spray fluid. The controller 236 receives the measured values (and optionally the measurements of one or more of the sensors 232, 234) and accordingly operates the spray fluid supply 600 to regulate the spray fluid including, but not limited to additive concentrations, spray fluid flow rates, total volume of the spray fluid or the like.

In another example, the spray fluid supply 600 includes a spray fluid temperature regulator 618. The spray fluid temperature regulator 618 in one example includes one or more heating or cooling elements, a thermometer or the like configured to regulate the temperature (e.g., heat or cool) the spray fluid prior to delivery to a sprayer array. Accordingly, the spray fluid temperature regulator 618 controls the spray temperature, for instance with an additive that provides enhanced treatment at a specified temperature (e.g., one or more of entraining, capturing, catalyzing, reacting or the like). In other examples, the adaptive spray cleaning systems described herein are used in ventilation or industrial gas systems. Accordingly, the spray fluid temperature regulator 618 heats or cools the spray fluid to accordingly heat or cool the gas treated with the adaptive spray cleaning systems (e.g., for residential cooling or heating, production gas treatment or the like).

In still another example, the spray fluid supply 600 in one example, includes a plurality of additive supplies 606. For instance, a plurality of additive supplies 606 includes, but is not limited to, a variety of different additives, additive purities or the like configured for controlled addition to the spray fluid. In one example, the controller 236, for instance shown in FIG. 2, operates each of the pumps, valves or the like associated with respective additive supplies 606 to control the inclusion (or exclusion) and concentration of each of the additives in the spray fluid. In another example, the fluid processor 610 previously described herein and shown in FIG. 6, is used in one example to remove one or more additives from the spray fluid, for instance, where the polluted gas does not include a particular component otherwise specifying the use of one or more of the additives. Accordingly, the spray fluid sump 602, specifically the fluid processor 610 in one example, is used to clean the spray fluid not only of pollutants or pollutant components therein but also of one or more additives that are no longer needed or specified for the spray fluid.

Referring again to FIG. 6 as previously described, the spray fluid supply 600 in one example includes one or more additive supplies 606. In one example, each of the one or more additive supply 606 includes one or more pollutant treating additives including, but not limited to, catalyzing additives configured to react with and break down one or more pollutants (e.g., pollutants within the polluted gas), capture media such as carbon dioxide capture media (e.g., sodium hydroxide, amines or the like), or hydrophilic additives including, but not limited to, one or more of sodium chloride or sodium hydroxide configured to maintain or adjust the volume of water in the spray fluid supply 600.

In one example, the pollutant treating additive includes a hydrophilic additive. The hydrophilic additive, depending on the concentration specified by the adaptive spray cleaning system facilitates the drawing or absorption of moisture from the polluted gas received in the adaptive spray cleaning system. With concentrations of the hydrophilic additive above an equilibrium threshold, the quantity of the spray fluid (e.g., water in this example) will gradually increase as the spray fluid absorbs additional fluid from the gas until equilibrium of the water relative to the hydrophilic additive is achieved. In another example, the decreasing of the hydrophilic additive concentration in the carrier fluid, for instance, by treatment at the spray fluid supply 602 with the fluid processor 610, allows for the evaporation of water from the spray fluid until an equilibrium value of the water in the spray fluid is reached for the concentration of the hydrophilic additive in the spray fluid.

Optionally, the hydrophilic additive is maintained in the spray fluid at a higher concentration than an equilibrium concentration (or threshold) to draw water into the system. Accordingly in one example, the spray fluid supply 600 is optionally used to collect water from the atmosphere and therefore may also be used as a water resource. For instance, for the harvesting of water for one or more uses including, but not limited to, use as the spray fluid, water used in manufacturing or power generation, potable water, irrigation or the like.

In another example, the hydrophilic additive concentration is decreased relative to an equilibrium concentration (or threshold). The carrier fluid (e.g., water) then evaporates from the spray fluid until a new equilibrium concentration is reached. The evaporation of water is used for cooling, in one example. Evaporation transfers heat from the polluted gas within the system (e.g., system 200 or other example systems herein) to the spray fluid. Accordingly, as the spray fluid evaporates (e.g., at least the water component of the spray fluid) evaporative cooling cools the polluted gas. In one example, the cleaned gas (e.g., with minimized pollutants) is used in a ventilation system, for instance, as cooled air delivered into one or more of residential buildings, homes, offices, structures or the like.

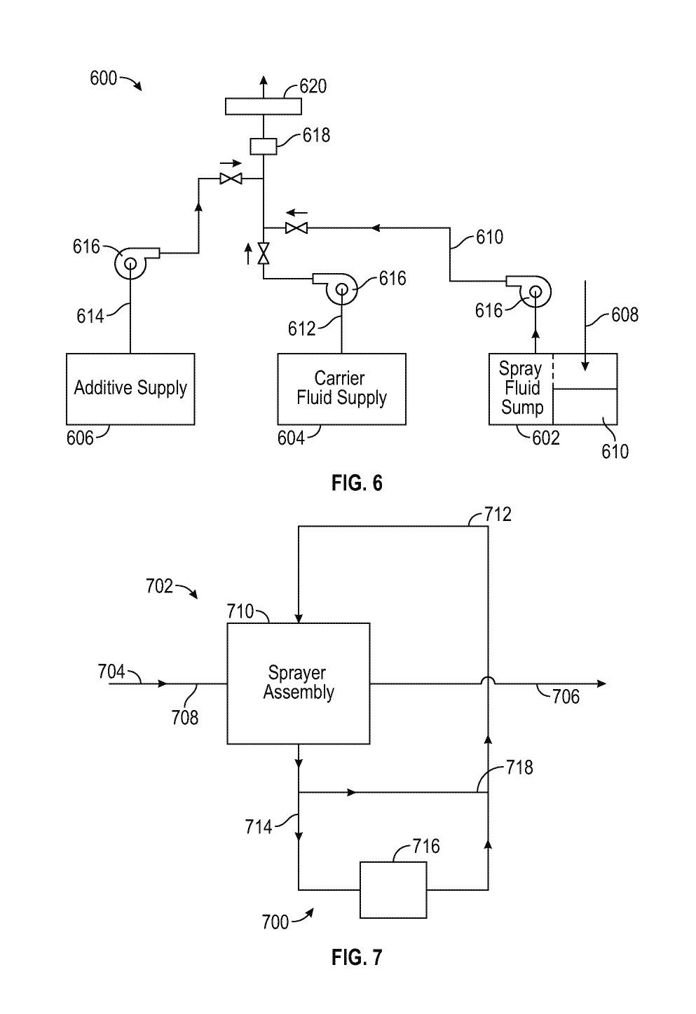

Referring now to FIG. 7, a schematic view of one example of an adaptive spray cleaning system 702 is provided. A spray fluid supply 700 is in communication with the sprayer assembly 710 of the adaptive spray cleaning system 702. As previously shown in FIG. 6, one example of the spray fluid supply 600 includes various reservoirs such as a spray fluid sump 602, carrier fluid supply 604 and one or more additive supplies 606. In the example shown in FIG. 7, the spray fluid supply 700 includes a streamlined system providing an array input 712 configured to provide the spray fluid to the sprayer assembly 710 and an array output 714 configured to return the used sprain fluid to the spray fluid supply 700, for instance, with entrained particulate, pollutant components or the like therein. In other regards, the adaptive spray cleaning system 702, including the sprayer assembly 710, operates in a similar manner to the cleaning systems described herein. For instance the system 702 includes a gas tunnel 708 having a gas inlet 704 and a gas outlet 706 with the sprayer assembly 710 provided in-line between the gas inlet and outlets 704, 706.

Referring again to FIG. 7, the spray fluid supply 700 is shown with an array output 714 that bifurcates into a bypass 718 and a fluid processor 716 as branches of the supply 700. The bypass 718 and the portion of the spray fluid supply 700 including the fluid processor 716 join again downstream from the fluid processor 716 into the array input 712 to supply the spray fluid to the sprayer assembly 710. In one example, the bypass 718 diverts a portion of the spray fluid, for instance, spray fluid including some amount of particulate, broken down pollutant or the like, back toward the array input 712 and the sprayer assembly 710.

Conversely, a portion of the spray fluid (e.g., a varying percentage based on pollutant measurements in the fluid or specified values of 5, 10, 15, 20 percent or so on) is instead diverted to the fluid processor 716. At the fluid processor 716, the spray fluid is cleaned, recycled, regenerated or the like. For instance, a filter or screening system is provided in one example to filter out particulate from the spray fluid. In another example, the fluid processor 716 includes one or more of cleaning or reactive chemicals configured to interact with one or more components of the spray fluid, for instance, captured pollutant components, particulate or the like to accordingly remove the same from the spray fluid. Optionally, in another example, the fluid processor 716 includes a distillation system configured to distill out the spray fluid and accordingly provide a purified spray fluid for mixing with the portion of the spray fluid otherwise delivered through the bypass 718.

As previously described in one example, the spray fluid includes one or more additives. For instance, one or more of capture media configured to capture pollutant components such as carbon dioxide, catalyzing additives configured to break down one or more pollutant components (e.g., sulfur dioxide or the like) or hydrophilic additives such as sodium chloride or sodium hydroxide configured to regulate the amount of water (an example of the carrier fluid for the additive) in the spray fluid. Additionally, one or more additives, including for instance, hydrophilic additives, such as sodium chloride, sodium hydroxide or the like are used as salts in the spray fluid to prevent (e.g., eliminate or minimize) microbial growth and thereby eliminate (e.g., minimize or entirely eliminate) the need for one or more additional additives such as biocides or the like in the spray fluid to prevent the growth of microbes therein.

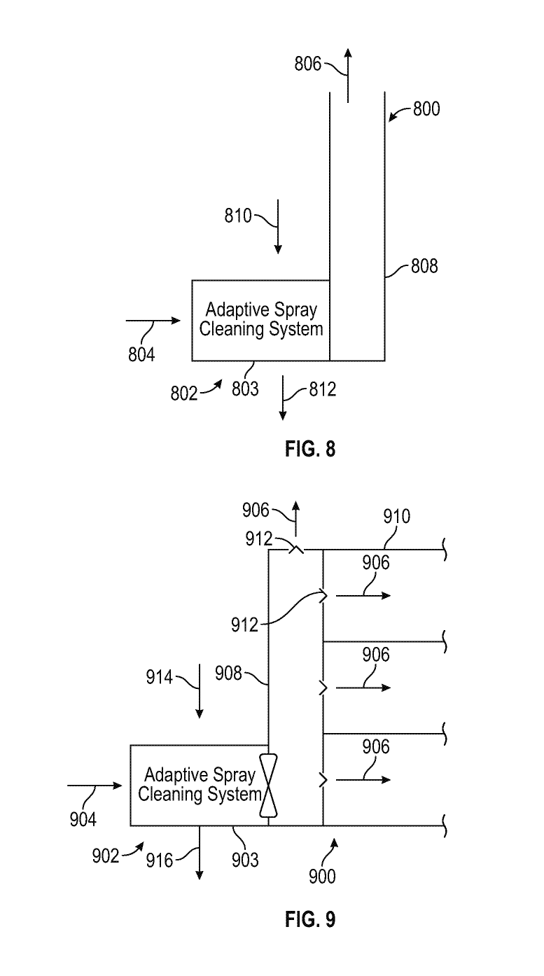

FIG. 8 shows one example of a heat transfer system 800. The heat transfer system 800 is optionally a component of a utility system, manufacturing environment or the like, including, but not limited to, a power plant. As shown in FIG. 8, the heat transfer system 800 includes an adaptive spray cleaning system 802 configured to regulate the temperature of a polluted gas as it is input into the adaptive spray cleaning system 802 and also operate as a heat transfer mechanism.

The adaptive spray cleaning system 802 includes a gas inlet 804, a gas outlet 806 and a gas tunnel 808 extending therebetween. As further shown, the adaptive spray cleaning system 802 includes a sprayer assembly 803 provided between the gas inlet 804 and the gas outlet 806. In the example shown in FIG. 8, the gas tunnel 808 in one example is a chimney, duct or the like extending vertically relative to the remainder of the adaptive spray cleaning system 802. In another example and as shown herein, the gas tunnel provided in a horizontal or angled configuration.

The adaptive spray cleaning system 802 in one example receives an inflow of polluted gas, such as relatively cool ambient air, at the gas inlet 804. The relatively cool polluted air is delivered through the adaptive spray cleaning system 802 (e.g., from the gas inlet 804 to the gas outlet 806) and sprayed a spray fluid to accordingly treat the air for one or more pollutants including, but not limited to particulate, gaseous pollutant components or the like. The spray fluid is optionally heated (e.g., by one or more of heat generated in other related or unrelated processes, by heating elements, solar heating or the like) and the spray fluid correspondingly heats the cooled polluted air while also removing one or more pollutant components from the polluted gas. At the gas outlet 806 a stream of cleaned and heated gas is provided. In the example where the heat transfer system 800 is used to clean and heat ambient polluted air, the gas inlet 804 receives polluted ambient air and the gas outlet 806 correspondingly exhausts warmed (relatively clean) ambient air, for instance, into the atmosphere, the interior of a building structure for ventilation, heating or the like.

As shown in FIG. 8 in one example, the input spray fluid 810 is a heated fluid while the output spray fluid 812 is a cooled fluid. In one example, the heated fluid includes, but is not limited to, condensed water converted from high pressure steam (used for instance in a power generation cycle). The condensed water is fed into the sprayer assembly 803 and is used as the spray fluid to remove one or more pollutants from the cool polluted gas received at the gas inlet 804. The cool polluted gas accordingly decreases the temperature of the heated water used in the spray fluid and accordingly the output spray fluid 812 is cooled. Afterwards, the output spray fluid 812 is in one example exhausted from the heat transfer system 800 for instance into lakes, rivers or the like. In another example, the output fluid 812 is recycled back into one or more processes, for instance, into a boiler for steam and power generation, use in one or more manufacturing processes or the like.

In yet another example, the heat transfer system 800 is in one example used in reverse. For instance, a heated polluted gas is received at the adaptive spray cleaning system 802 and is corresponding cleaned and cooled when exhausted at the gas outlet 806. Correspondingly, the input spray fluid 810 is in one example a relatively cool fluid (compared to the heated gas) delivered through the adaptive spray cleaning system 802. The output spray fluid 812 is heated according to heat exchange from the polluted gas to the spray fluid. In one example, the adaptive spray cleaning system 802 is used as a preheater prior to delivery of a fluid such as water to a boiler. Accordingly, with preheating by the adaptive spray cleaning system 802 resources are conserved at the boiler and the water is optionally provided at a temperature approaching the water to steam transition temperature to maximize the efficient generation of power (production of steam used at a turbine to generate power).

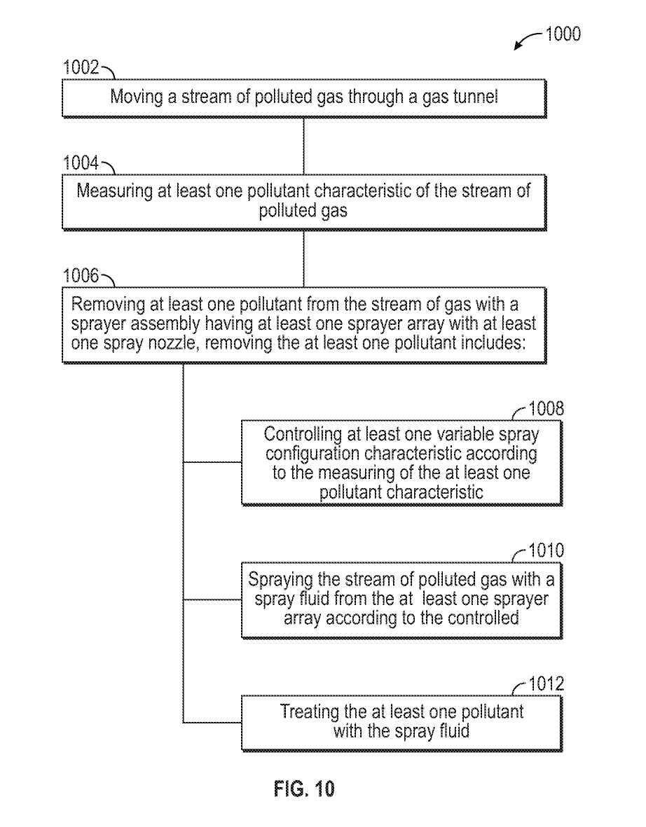

FIG. 9 shows one example of a ventilation system 900 including an adaptive spray cleaning system 902. In many regards the adaptive spray cleaning system 902 includes components previously described and shown herein including, but not limited to, one or more sprayer arrays, such as the sprayer arrays 212, 214, 216 shown in FIG. 2, each including one or more spray nozzles. In the example shown in FIG. 9, the ventilation system 900 includes one or more components of the adaptive spray cleaning system 902 including a gas tunnel 908 (e.g., a ventilation shaft in one example), gas inlet and gas outlet 904, 906. As further shown in FIG. 9, the system 902 includes a plurality of gas outlets 906 configured to deliver a cleaned gas to the atmosphere and one or more roomz, zones, floors or the like of a structure 910 (e.g., a building, vessel or the like) through dampers 912.

The adaptive spray cleaning system 902 includes a sprayer assembly 903 similar at least in some regards to the sprayer assembly described herein (e.g., including one or more sprayer arrays). As shown, a polluted gas such as a cooled polluted gas is received at the gas inlet 904 and is delivered through the sprayer assembly 903. The adaptive spray cleaning system 902 provides one or more sprays of a spray fluid (e.g., heated in one example above the temperature of the cooled polluted air received at the gas inlet 904) at the spray fluid input 914 and the spray fluid is used to treat (e.g., entrain, capture or catalyze) one or more pollutant components in the polluted gas received at the gas inlet 904. Heat transfer occurs between the heated spray fluid and the cooled polluted gas with the spray fluid exiting the adaptive spray cleaning system 902 (from the spray fluid outlet 916) at a relatively cooler temperature and the cleaned polluted gas exiting the sprayer assembly 903 at a (relatively) heated temperature. In one example, the cleaned and heated gas is delivered, for instance through the gas tunnel 908 and distributed through the structure 910 at one or more gas outlets 906 including for instance, dampers 912 provided at a variety of floors or locations within the structure 910. Optionally, filters (replaceable, washable or the like) are provided at one or more of the gas outlets 906 (or downstream from the spray assembly 903) to capture droplets of the spray fluid, remaining particulate matter or the like prior to delivery of the gas.

In each of the examples shown in FIG. 8 and FIG. 9, for instance, with the heat transfer system 800 and the ventilation system 900, the inclusion of an adaptive spray cleaning system 802, 902 facilitates the regulated operation of the sprayer assemblies 803, 903 to accordingly react and adjust to differing pollutant components and concentrations in the polluted gas received at the sprayer assemblies 803, 903. Accordingly, cleaned and in some instances, heated or cooled gases, are exhausted by the adaptive spray cleaning system 802 (or 902) with a specified air quality.

In another example, changes in ambient air quality, for instance, with spikes of one or more pollutants are readily adjusted to by the adaptive spray cleaning systems 802, 902 for instance with the methods and structure described herein (e.g., with the spray assembly control system 230 that operates one or more sprayer arrays, spray fluid supplies or the like). The adaptive operation of the spray cleaning systems 802, 902 (200 and the like described herein) ensures the exhausted gas, for instance, exhausted ambient air, production gas or the like from each of the systems is provided at a specified quality (e.g., air quality, specified pollutant quantity such as parts per million or the like) even with changes in pollutant characteristics of the input gas to the adaptive spray cleaning systems. For instance, in one example, where the concentration of one or more pollutants increases relative to previous conditions, the adaptive spray cleaning systems described herein are configured to adapt and adjust operation of the sprayer assemblies to accordingly remove a corresponding higher concentration of the pollutants from the polluted gas. The resulting exhausted gas, for instance from the gas outlets 806, 906 in FIGS. 8 and 9, is provided in a predictable specified fashion (e.g., with a specified decrease in the pollutant concentration in the exhausted gas). Similarly, where one or more pollutant concentrations decrease relative to previous conditions the adaptive spray cleaning systems described herein are configured to adjust the output of the sprayer assemblies 803, 903 (e.g., variable spray configuration characteristics including, but not limited to, one or more of flow rates, sprayer arrays used, nozzle density, nozzle orientation, additive concentrations or the like) to achieve the specified concentration of a pollutant in the exhausted gas to.

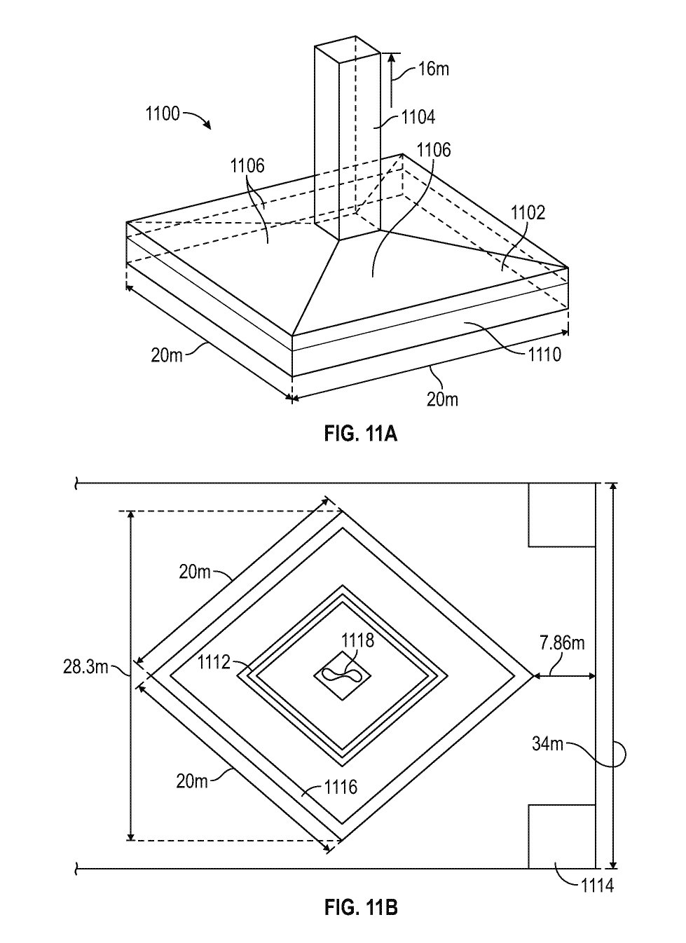

FIG. 10 shows one example of a method 1000 for adaptively cleaning a stream of polluted gas for instance with one or more of the systems as described herein. In describing the method 1000, reference is made to one or more components, features, functions, steps or the like described herein. Where convenient reference is made to the components, features, functions, steps or the like with reference numerals. Reference numerals provided are exemplary and are not exclusive. For instance, the components, features, functions, steps or the like described in the method 1000 include, but are not limited to, the correspondence numbered elements or other corresponding features described herein (both numbered and unnumbered) as well as their equivalents.

At 1002 the method 1000 includes moving a stream of polluted gas (e.g., the polluted gas) through a gas tunnel. One example of gas tunnel 202 is shown for instance in FIG. 2. Optionally, the polluted gas is moved through the gas tunnel 202 with one or more gas movers including a passive gas mover (for instance with the gas tunnel 202 being provided on an angle or with a vertical orientation and solar or passive heating is used to heat the polluted gas cause it to rise within the gas tunnel 202). In another example, the gas mover includes an active gas mover such as a fan or blower, for instance, the gas movers 208 shown in FIG. 2.

At 1004 at least one pollutant characteristic of the polluted gas is measured. For instance, one or more sensors, such as an inlet sensor 232, an outlet sensor 234 or both are provided with the adaptive spray cleaning system 200 shown in FIG. 2. In one example, the one or more sensors 232, 234 (each optionally including one or more sensors) are configured to measure one or more pollutant characteristics including, but not limited to, particulate size, particulate density (e.g., a particulate count), conduct one or more of chemical analysis or the like to accordingly identify a pollutant, its concentration or the like.

At 1006 the at least one pollutant (e.g., a particulate pollutant chemical or gaseous pollutant or the like) is removed from the stream of polluted gas with the sprayer assembly such as the sprayer assembly 210 shown in FIG. 2 (as well as any of the other examples described herein). As previously described, the sprayer assembly 210 includes at least one sprayer array 212 (and one or more of the sprayer arrays 214, 216 or any combination of sprayer arrays provided herein) with each of the sprayer arrays having at least one nozzle, such as a spray nozzle 218. In one example, removing at least one pollutant from the pollutant gas includes at 1008 controlling at least one variable spray configuration characteristic according to the measuring of the at least one pollutant characteristic of the stream of polluted gas. The at least one variable spray configuration characteristic includes, but it is not limited to, one or more of nozzle density, nozzle direction (orientation, angle or the like), nozzle array selection (for instance with a plurality of nozzle arrays for selection), droplet size, droplet charge, spray fluid compositions, spray fluid temperature and spray fluid output (e.g., flow rate) or the like.

At 1010 the method 1000 includes spraying the polluted gas with the spray fluid from the at least one sprayer array for instance, one or more of the sprayer arrays 212, 214, 216 shown in FIG. 2. The polluted gas is sprayed with the spray fluid in a controlled fashion, for instance, according to the one or more controlled variable spray configuration characteristics specified based on the measured at least one pollutant characteristic. As previously described herein, the adaptive spray cleaning system 200 in an example includes the controller 236 in communication with the sensors 234, 234, one or more of the sprayer arrays 212, the spray fluid supplies 222, 224 or the like. Accordingly, in at least one example, the controller 236 is regulates the spraying of the polluted gas with the spray fluid with one or more selected variable spray configuration characteristics based on the measured at least one pollutant characteristic.

The spraying of the polluted gas with the spray fluid, for instance from the one or more sprayer arrays, accordingly treats the at least one pollutant with the spray fluid at 1012. For instance, in one example, treating the at least one pollutant with the spray fluid is configured to entrain one or more particulate pollutants within the pollutant gas. In another example, treatment of the at least one pollutant with the spray fluid includes the application (through the spray fluid) of one or more additives configured to interact or capture one or more pollutant components in the pollutant gas. For instance, the spray fluid in one example includes a capture media, such as a carbon dioxide capture media, configured to interact with and capture carbon dioxide within the polluted gas. In another example, the spray fluid includes one or more other chemicals, additives or the like configured to interact with and catalyze one or more pollutants within the polluted gas.

Several options for the method 1000 follow. In one example, measuring of the at least one pollutant characteristic includes ongoing measurements of the at least one pollutant characteristic. For instance, the measurement of the at least one pollutant characteristic is carried out at an interval, continuously or the like. In another example controlling the at least one variable spray configuration characteristic includes feedback controlling the at least one variable spray configuration characteristic according to the ongoing measuring. For instance, in one example, one or more of flow rate additive concentration, nozzle density, nozzle array selection or the like (e.g., examples of the variable spray configuration characteristics), is accordingly controlled by way of a feedback loop maintained between the system controller 236 and one or more sensors, for instance, one or more of the inlet and outlet sensors 232, 234.

The at least one measured pollutant characteristic includes one or more of particulate size, particulate density (count) or identification of a pollutant or its concentration within the polluted gas. In one example, controlling the at least one variable spray configuration characteristic includes controlling a droplet size for the spray fluid according to the measured particulate size. The method 1000 further includes spraying the stream of gas with the spray fluid including spraying the polluted gas with a droplet size corresponding to the measured particulate size. In another example, the at least one pollutant characteristic includes a particulate density (count) or the like. Similarly, controlling the at least one variable spray configuration characteristic includes optionally controlling a droplet size for the spray fluid according to the measured particulate density or count. With higher particular counts, a finer spray is used in one example to accordingly entrain more of the concentrated particulate in the pollutant gas. Conversely, with a decreased concentration of a particulate, a larger droplet size (e.g., for instance from another sprayer array having larger nozzles) is operated to provide larger droplets readily used with a lower particulate count to accordingly treat the polluted gas with the particulate while at the same time conserving resources.

In another example, the at least one pollutant characteristic includes a particulate density. In an example controlling the at least one variable spray configuration characteristic includes controlling a nozzle density (e.g., a number of nozzles, number of nozzles within a particular area of the gas tunnel or the like) according to the measured particulate density. Method 1000 further includes an example of spraying the polluted gas with the spray fluid including spraying the stream of gas with a plurality of nozzles corresponding to the controlled nozzle density. Optionally, controlling the nozzle density includes selecting a first nozzle array with the measurement of the first particulate density and selecting a second nozzle array with the measurement of the second particulate density. In one example, the second particulate density is greater than the first particulate density and the second nozzle array includes a greater number of nozzles than the first nozzle array. Optionally, the second nozzle array including the greater number of nozzles in one example is configured to provide a finer droplet size, for instance, a smaller droplet size relative to the first nozzle array.

In another example, the at least one pollutant characteristic measured with the one or more sensors includes a pollutant concentration. The spray fluid includes a variable concentration of a pollutant treating additive in another example. The method 1000 in this example includes controlling at least one variable spray configuration characteristic such as the variable concentration of the pollutant treating additive in the spray fluid according to the measured pollutant concentration. In another example, the polluted gas is sprayed with the spray fluid including spraying of the polluted gas with the spray fluid including the pollutant treating additive having a concentration corresponding to the measured pollutant concentration. In another example, controlling the variable concentration of the spray fluid includes selecting a first variable concentration with the measurement of a first pollutant concentration (e.g., with one or more of the sensors such as the inlet and outlet sensors 232, 234) and selecting a second variable concentration with the measurement of the second pollutant concentration, wherein the second pollutant concentration is greater than the first pollutant concentration. The corresponding second variable concentration of the pollutant treating additive is greater than the first variable concentration, for instance, corresponding to the greater concentration of the pollutant (the second pollutant concentration) in the polluted gas.

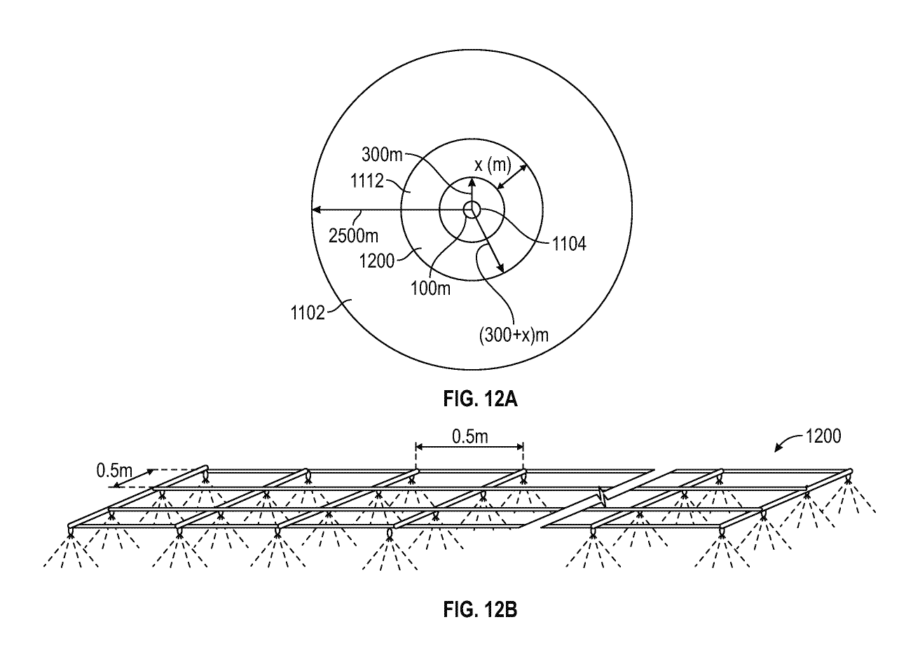

Various examples including one or more of the features, functions or elements previously described herein are described as prophetic examples below and shown in FIGS. 11A-14B. These examples illustrate the application of a plurality of the concepts previously discussed herein.

As previously described, the filtering of atmospheric pollutants (e.g., from ambient air) including particulate matter such as PM_{2.5} from the atmosphere is desirable to improve air quality in urban and industrial centers, as well as in offices, homes and other structures. Atmospheric pollution includes suspended particulate matter (PM) and precursor gases to secondary PM_{2.5} formation in the atmosphere, such as sulfur dioxide (SO₂), nitrogen oxides (NOₓ) and volatile organic compounds (VOCs) and ammonia (NH₃).

The systems described herein treat polluted gases such as air for instance by removing, catalyzing, capturing pollutants or the like. One example of a system includes a solar assisted cleaning system 1100 shown in FIGS. 11A, B. The system 1100 is configured to process a particulate loaded atmosphere. As described herein, the solar assisted cleaning system 1100 includes a tapered shroud 1102 consisting of glass panels 1106 (in some cases a kilometer or more in diameter) that taper from an elevated central portion (e.g., near a tower 1104) toward a lower peripheral portion 1110. A clean air tower 1104 is positioned within the elevated central portion and includes one or more inlet ducts in communication with the area beneath the tapered shroud 1102. The tapered shroud 1102 heats air beneath the shroud (e.g., like a greenhouse, or by way of heating with photovoltaic elements or the like). The heated air rises within the tapered shroud 1102 and is delivered toward the clean air tower 1104 according to the taper. The movement of the air draws additional air into the tapered shroud at the lower peripheral portion 1110.

As shown in FIG. 11B, an adaptive spray cleaning system 1112 is included in the shroud 1102, for instance near to one or more of the elevated central portions and the clean air tower 1104. The system 1112 captures particulates and accordingly allows the otherwise heated (cleaned) air to continue on to the clean air tower 1104 for exhausting. The system 1112 includes one or more sprayer arrays (with examples described herein) provided beneath the elevated central portion of the tapered shroud. The one or more sprayer arrays include a plurality of spray nozzles (e.g., nozzles, pores, openings or the like in distribution piping) and the plurality of spray nozzles are configured to shower incoming air including particulate (e.g., PM_{2.5}) with a spray fluid, such as water, a carrier fluid including one or more pollutant treating additives or the like. The spray fluid entrains the particulate and effectively removes the particulate from the air. The spray fluid with the entrained particulate is received in a liquid collection trough, catch basin, reservoir or the like. Optionally, the spray fluid is treated (e.g., filtered, treated or the like) for instance at a fluid processor 1114 to remove the particulate and recycle the spray fluid for use again in the one or more sprayer arrays.

Optionally, solar panels 1116 are installed on the shroud (or remotely) to generate electricity used to power one or more gas movers 1118 (e.g., fans, blowers or the like) located inside the system 1100. With the adaptive spray cleaning system 1112 the pressure drop across the sprayed fluid is minimal compared to that of a cartridge filter system. The electrical power generated by the solar panels is thereby sufficient to drive the fan to increase and regulate flow through the system 1100.

The glass panels 1106 (e.g., an example of a translucent gas tunnel material) on the shroud 1102 are coated with catalysts (including, but not limited to TiO₂, other photocatalysts, nanomaterials or the like) on one or more of the upper and lower surfaces of the glass panes 1106. Upon irradiation by sunlight, the upper surface photo-oxidizes deposited soot and contaminants. The broken down contaminants are washed off by rain for self-cleaning. The air in the space between the shroud and the ground is turbulent (e.g., part of the gas tunnel described herein). The catalysts photo-oxidize the precursor gases of VOCs, NOₓ and SO₂ that form the secondary PM_{2.5} in the atmosphere.

Each of the embodiments provided herein are optionally scaled to sizes of a kilometer or more (e.g., the tapered shroud optionally includes a diameter of a kilometer or more) to facilitate cleaning of the atmosphere on a corresponding large scale. The shroud 1102 includes a varied shape (e.g., rectangular) to fit inside a city block or circular (full or partial arc) to efficiently fit in rural areas. The use of renewable resources including water and solar power minimizes (e.g., eliminates or minimizes) the energy input needed for operating the system 1100. Further, the system 1100 optionally does not use filters that require disposal and replacement.

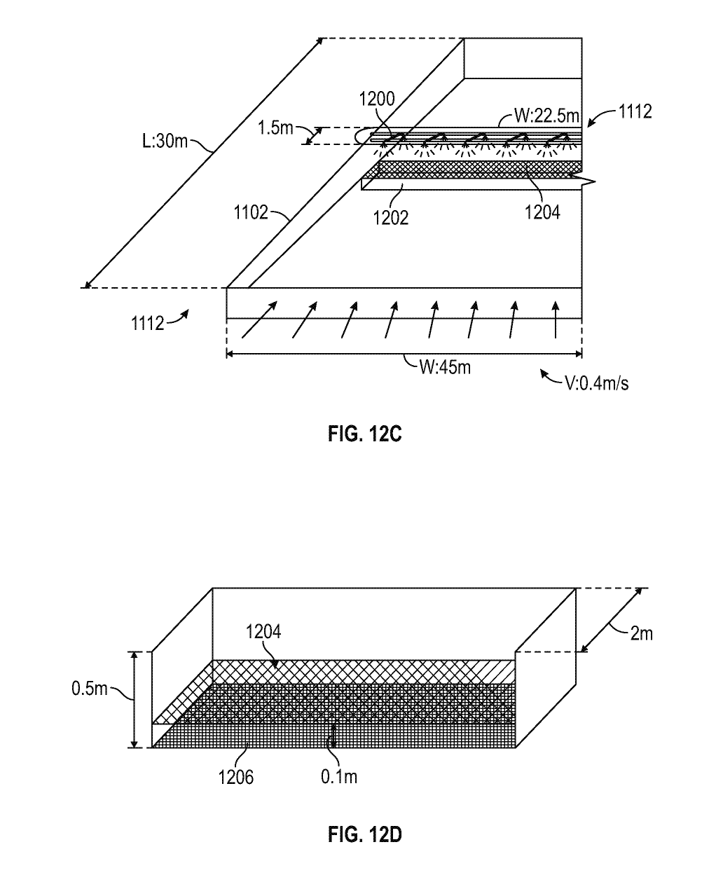

Referring now to FIGS. 12A, B, the adaptive spray cleaning system 1112 (optionally used with the solar assisted system 1100 or used cooperative with other systems or independently as described herein) includes one or more sprayer arrays 1200 of a plurality of nozzles installed close to the tower 1104 (FIG. 11A) to collect the PM_{2.5} effectively and at a low cost. The water drops coalesce (e.g., entrain) the PM_{2.5} as they fall from the top of the shroud 1102. The system 1100 provides adaptive spray arrays as described herein to provide sprayed fluid in a controlled manner to ensure the success of the coalescing (entrainment) process. As shown in FIG. 12A (for a large circular unit with 2.5 km radius), the sprayer arrays 1200 are installed below an elevated portion of the shroud 1102 from a distance of around about 300 meters to 420 meters from the tower axis. The sprayer arrays and the dispensed spray fluid are spaced from the tower 1104 to maximize the falling of the spray droplets below the shroud 1102 and minimize the entry of spray droplets into the tower 1104. As discussed herein, a portion of the recovered spray fluid (e.g., 1 percent or more) is passed through a liquid filtration system and the solid particulate is removed and other pollutants are optionally treated or removed.

In one example, commercial nozzles are used to produce different spray droplet sizes and produce sprays having specified flow rates under specified pressures. With a combination of available nozzles deployed in the system the droplet size, droplet intensity, and the system 1100 air flow rate, can remove PM2.5 efficiency of 80 percent or greater. The PM2.5 saturated spray fluid is drained into a collecting pond, tank, catch basin, reservoir or the like where the spray fluid is processed (e.g., filtered, screened, treated or the like) to remove the PM2.5. The recycled spray fluid is optionally supplied again to the sprayer arrays 1200. This facilitates a low cost and sustainable operation for the system 1100.

The following paragraphs include the detailed design of an example medium-size adaptive spray cleaning system, as well as PM2.5 removal efficiency calculations. FIG. 12C is a schematic diagram of a portion of the adaptive spray cleaning system 1112 with the nozzles of at least one sprayer array 1200 positioned approximately midway in a duct plenum (e.g., the shroud 1102 having a width or radius of around 22.5 m), or 13.5 m away from the center of the tower 1104. A spray fluid catch basin 1202 with 22.5 m (length)×2 m (width)×0.5 m (height) is installed below the sprayer arrays 1200 to catch the spray fluid (e.g., with entrained, captured or treated pollutant components therein). A screen 1204 is optionally placed above the bottom of the catch basin 1202 so that large particles and agglomerates pass through the screen and settle (e.g., as settlement 1206 shown in FIG. 12D) in the quiescent spray fluid (e.g., water) below. Above the screen 1204, the particulate laden spray fluid is drawn out to a fluid processor 1114 (e.g., such as a water filtration system). Once the spray fluid is filtered, it is optionally recycled by feeding it to the sprayer arrays 1200 by a pump.

Based on an estimated gas flow rate of 40.1 m³/s and dimensions of the example adaptive spray cleaning system 1112, the droplet size (mm) and precipitation intensity (mm/hr) from the sprayer arrays 1200 are calculated according to equations (e.g., 20.45-20.57 in Seinfeld and Pandis (2006)) to ensure a mass removal efficiency of greater than 80 percent for PM2.5. It is found that when the droplet diameter is 0.5 mm, the adaptive spray cleaning system 1112 has a nearly optimal operation, in terms of low spray fluid usage (e.g., water), low evaporation, high PM2.5 removal efficiency and the like. Table 1 (below) shows the removal efficiency of the 0.5 mm droplet diameter system 1112 for particles with a range of sizes. The PM2.5 removal efficiency is around 80 to 100 percent when the precipitation intensity (RS intensity) is 530 and 800 mm/hr, respectively.

TABLE 1
Particle removal efficiency versus particle size by the 0.5 mm
spray fluid (e.g., water) droplets at 530 and 800 mm/hr precipitation
intensities (RS intensities).
water droplet size 0.5 mm or 500 μm (Vts = 2.1 m/s)

RS intensity (mm/hr)

| particle size (μm) | 530 | 800 |
|---|---|---|
| 0.1 | 100% | 100% |
| 0.3 | 78% | 100% |
| 0.5 | 67% | 100% |
| 0.8 | 74% | 100% |
| 1 | 85% | 100% |
| 2.5 | 100% | 100% |
| 10 | 100% | 100% |

An example depth of the droplet spray coverage (e.g, the depth of nozzle deployment) is calculated by multiplying the air velocity and the total time for a droplet falling from the sprayer arrays 1200 to the bottom of the shroud 1102 (e.g., the bottom of the gas tunnel), which in one example is around 1 meter. In other examples, calculations are conducted based on other values, droplet sizes or the like. By spraying droplets with this depth, the continuously incoming PM2.5 is effectively removed according to the calculated efficiency. Therefore, the total required spray fluid usage is, in an example, 0.53 meters per hour multiplied by 22.5 meters multiplied by 1 meter, or around 12 cubic meters per hour (e.g., around 53 gallons per minute) for an 80 percent PM2.5 removal efficiency and around 18 cubic meters per hour or around 81 gallons per minute to achieve a near 100 percent PM2.5 removal efficiency. These calculations are examples and the actual efficiencies, depths of the sprayer arrays 1200 or the like may vary in actual practice or with consideration of other design factors.

By considering the droplet size (e.g., the number median diameter or NMD), flow rate capacity, spray angle and specified pressure, the full cone nozzle ⅛ G-3 from Spraying System Co., Wheaton, Ill., is used in an example. This nozzle produces droplets with VMD (volume median diameter) of 1.6 millimeters, a spray angle of around 60 degrees and a capacity (e.g., flow rate) of around 0.3 gallons per minute at 10 psi. The corresponding NMD is around 0.5 millimeters when assuming the geometric standard deviation is 1.8. An example nozzle deployment scheme is shown in FIG. 12B for the 80 percent efficiency example. The total number of the ⅛ G-3 nozzles is 180 (4×45). In the example, a 1.5 meter depth is used instead of the example calculated 1 meter depth in consideration of a safety factor and the angle of the spray.

An example evaporation loss of spray fluid, such as water, from the spray droplets and found it is approximately 870 liters per pour for historical summer conditions. The loss is optionally replenished by adding makeup water from a water source, using hydrophilic additives (as described herein) or the like.

In one example, delivery of spray fluid to the example 180 nozzles is conducted simultaneously, for instance with a water pump with around a 10 horsepower motor, such as 12A081 from Dayton or 9BF1L4A0 from Goulds Water Technology. These pumps have a flow rate of 50-300 gallons minute at 50-250 ft of head. The spray fluid include entrained particulate is in one example filtered by a super-high-flow filter system (Part 3455K21 and 3455K35, McMaster Carr, Elmhurst, Ill.) having a design flow capacity of 150 gallons per minute.

The total cost of the example adaptive spray cleaning system 1112 system is less than 20,000 USD compared to more than 100,000 USD for a cartridge filter system. The adaptive spray cleaning system 1112 has advantages of low pressure across the sprayer arrays 1200, low cost, and minimal solid waste disposal problems relative to cartridge filter systems. It is a sustainable system for removing PM_{2.5} and other pollutant components from gases, including ambient air.

Optionally, the shroud 1102 (shown in the examples of FIGS. 11A, B and 12A) is minimized or removed with the inclusion of a gas mover, such as a fan, blower or the like if solar heating and corresponding air movement are not used. The tower is also optionally eliminated or minimized as there is no need for a chimney to provide draft. Instead, a gas tunnel shown in some examples herein is instead used to house the one or more sprayer arrays 1200 and facilitate the delivery of gas therethrough. This facilitates the shrinking of the system (e.g., reduces its profile within a structure, city block or the like) and minimizes the initial construction costs. Solar photovoltaic panels are optionally mounted on the system (e.g., such as a remaining portion of the shroud 1102) or elsewhere on a building, structure, remotely or the like to provide some or all the electric power to operate the gas mover so the system 1112 is still solar assisted.

Optionally, the flow direction of the gas through the system 1112 (e.g., as part of the solar assisted cleaning system 1100) is varied according to the heating or cooling of the gas received in the system 1100. For example, with heat added to the air during the cleaning process (e.g., in a cooling tower application) the gas enters the system at the perimeter of the shroud 1102 and leave from the tower 1104 to reduce the likelihood of the warm, buoyant air that leaves being re-entrained back into the system 1100. Accordingly, a gas mover, such as a fan should in one example drawe air into the system from the shroud 1102 and blowing toward the upper portion of the tower 1104 (see FIGS. 11A, B). Conversely, when no heat is added to the gas during the cleaning process or the gas is cooled with the adaptive spray cleaning system 1112 (e.g., and using nearly pure water, treated spray fluid or the like) the gas mover optionally draws gas downward from the opening at the upper portion of the tower 1104 and discharges the cleaned gas from the perimeter of the shroud 1102. This minimizes the reintroduction of cleaned gas (e.g., air) into the system 1100 and also provides cool, clean air at a low velocity near the base of the unit. In some examples, this provides localized air cleaning and air conditioning for the area near the system 1100, within a semi-enclosed courtyard, within a structure or the like.

In other examples, CO₂ treatment is performed at the source of CO₂ generation, for instance at smoke stacks to treat flue gas. Stated another way, the capture of CO₂ is conducted at the flue stack or within cross-flow cooling tower type packed towers. In contrast, the examples described herein use one or more sprayer arrays 1200 to remove CO₂. Optionally, CO₂ is removed simultaneously with PM_{2.5} in the adaptive spray cleaning system 1112. In such an example, construction, utility usage and capital cost is shared and largely reduced for the additional CO₂ removal.

As described herein, the sprayer arrays 1200 in one example are configured to use a spray fluid (e.g., including a carrier fluid such as water) having a carbon dioxide capture media as the pollutant treating additive (e.g., a capture media soluble in water). The carbon dioxide capture media removes the atmospheric CO₂ inside the adaptive spray cleaning system 1112. The sprayed carbon dioxide capture media (e.g., NaOH, amines or the like) in a liquid base (e.g., a carrier fluid such as water) increases the contact interface with the gas (such as ambient air, production gases or the like) and effectively removes the CO₂. In an example, titanium dioxide (TiO₂) is used as a causticization agent for sodium carbonate because the total energy consumption is at least 50 percent lower than that of using Ca(OH)₂. The overall reactions of sodium hydroxide recovery and CO₂ capture are as follows with TiO₂ used as the exemplary causticization agent:

2NaOH+CO₂→Na₂CO_{3(aq)}+H₂O (capture) (1)

7Na₂CO_{3(aq)}+5(Na₂O.3TiO₂)₍ₛ₎↔3(4Na₂O.5TiO₂)₍ₛ₎+7CO_{2(g)} (intermediate and isolation of captured CO₂) (2)

3(4Na₂O.5TiO₂)₍ₛ₎+7H₂O↔5(Na₂O.3TiO₂)₍ₛ₎+14NaOH_{(aq)} (recycling of the carbon dioxide capture media) (3)

The overall quantity of CO₂ in the atmosphere is about 3000 Gt and the total mass can be reduced by 400 Gt to 2600 Gt with the systems described herein. The total air flow rate generated by the full scale system 1100 shown in FIGS. 11A, B is about 3.8×10⁵ m³/s, meaning the capacity of CO₂ removal by the system 1100 is around 4 MtCO²/yr. Therefore, the total world-wide construction and deployment rate will be around 20 units per year or fewer if the intake flow rate of the system 1100 is further enhanced.

Another option to enhance CO₂ collection is by enhancing the collecting efficiency of CO₂. In the system 1100 described previously the contact of CO₂ and NaOH solution is volume based with an estimated total of around 4×10⁵ cubic meters as opposed to a relatively smaller surface based system providing a two dimensional curtain of carbon dioxide capture media). It is expected the CO₂ collection efficiency with the volume based (e.g., including the depth dimension described herein) sprayer arrays 1200 will be higher than 50 percent. The other important parameter is the flow velocity of the gas that influences residence time and the removal efficiency of CO₂. The average flow velocity inside the system 1100 is 4 meters per second. However, because there is much higher contact volume in the sprayer arrays 1200 of the adaptive spray cleaning system 1112 the relatively high velocity (e.g., used in a two dimension surface area based system) should not impact the treatment efficiency in the the system 1100. For conservative estimation purposes, a 50 percent removal efficiency is provided in this description, though the efficiency may in practice be greater.

Another design consideration for the adaptive spray cleaning systems described herein is water loss during operation. Water loss and the incidental change of NaOH concentration is influenced by the concentration of NaOH, ambient temperature, relative humidity (R_{H}) as well as the removal efficiency of CO₂. While NaOH is listed herein as the carbon dioxide capture media the embodiments described herein are not limited to NaOH, instead one or more capture media is used including, but not limited to NaOH, amines or the like. The water loss, R_{H2O/CO2} (mol H₂O per mol of CO₂ removed) was calculated assuming Tₒᵤₜ=Tᵢₙ as:

$$\begin{matrix}{R}_{{H}_{2} O \text{/} {CO}_{2}} = {M}_{{H}_{2} O} [ {P}_{v} ( {T}_{out} ) S - {P}_{v} ( {T}_{in} ) {R}_{H} ] \text{/} ( {M}_{{CO}_{2}} Δ {P}_{{CO}_{2}} ) \\ = {M}_{{H}_{2} O} [ {P}_{v} ( {T}_{in} ) ( S - {R}_{H} ) ] \text{/} ( {M}_{{CO}_{2}} Δ {P}_{{CO}_{2}} )\end{matrix} \qquad ( 4 )$$

where M_{H2O}: molecular weight of H₂O; M_{CO2}: molecular weight of CO₂, Pᵥ: vapor pressure of water; Tᵢₙ: ambient temperature; Tₒᵤₜ: temperature leaving the absorber; S: degree of saturation of air in equilibrium with NaOH solution (referred to in FIG. 3); and ΔP_{CO2}: difference of partial pressure of CO₂ between ambient and outlet. In one example, a zero loss or a loss close to zero (of the spray fluid, such as water) is designed for.

From Eq. (4), it is found the higher Tᵢₙ (ambient temperature) and lower R_{H} (relative humidity), there will be a higher water loss if the S is kept constant (e.g., a fixed NaOH concentration). The annual climate data of Beijing (as an example) shows May (20° C. and average R_{H}=49 percent) is likely to have the most water loss over a year because of the relatively high temperature and low R_{H}. According to Eq. (4) and assuming Tₒᵤₜ=Tᵢₙ=20° C., concentration of NaOH=5 M (S=80) and ΔP_{CO2}=250 Pa (50 percent removal, from 500 ppm to 250 ppm), the water loss is around 12 mol H₂O/mol CO₂. In one example the adaptive spray cleaning system 1112 removes around 5×10⁵ tons of CO₂ and experiences 2×10⁶ ton of water loss, which was estimated to be additional $20 million cost ($1/ton water) in the month of May for conditions in Beijing. This estimated loss is optionally reduced by varying the NaOH concentration. For example, increasing NaOH concentration to 9 M (S around 50 percent), the water loss is reduced to about zero and a negative value (absorption of water) is achieved by further increasing the NaOH concentration. Alternatively, the water concentration is controlled by addition or removal (regulation) of water, for instance with the systems described herein including the controller 236. Based on the above discussion, an automatic control system (e.g., the sprayer control system 230) achieves and maintain an optimal operating condition to minimize water loss while keeping the cost of NaOH (or other carbon dioxide capture media) low.

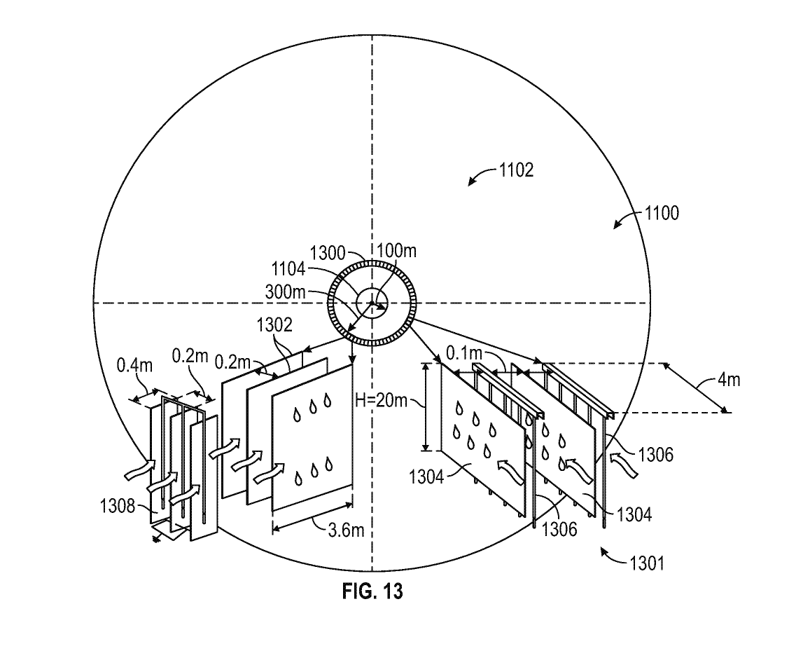

Referring now to FIG. 13, high efficiency with low pressure drop is a beneficial design feature of Electrostatic Precipitators (ESP). The ESP system can remove a significant amount of particles from the gas that passes through it, optionally, the electrostatic precipitator is used alone or in combination with the adaptive spray cleaning systems described herein (e.g., another stage of gas cleaning). As shown in FIG. 13, in one example the electrostatic precipitator system 1300 is installed from a distance of around about 300 m to 304 m from the tower 1104 axis of the system 1100. The electrostatic precipitator system 1300 includes one or more of a single stage or multi (two) stage electrostatic system. In one example, the system includes 1300 collecting plates 1304 interleaved between discharge electrodes 1306. The collecting plates are optionally around 4 meters long due to the relatively high efficiency of the system 1300. In the example shown (e.g., on the right of FIG. 13) the wire-in-plate single stage system 1301 uses a high supply voltage (10,000 volts or more) provided to discharge electrodes 1306 suspended between the collecting plates 1304. In the other example (e.g., shown on the left side of FIG. 13) a two stage electrostatic precipitator system is shown that operates with a lower voltage (10,000 volts or less) provided to the discharge electrodes 1308 (e.g., plates) and a second stage (downstream from the electrodes) including the collecting plates 1302. The PM_{2.5} removal efficiency is estimated by the Deutsch-Anderson equation to be greater than 90 percent. The collected PM_{2.5} is periodically washed down by a water film supplied from spray nozzles located near the top of the shroud 1102 (e.g., the gas tunnel).

In still another example, during the discharge of waste water to a body of water (e.g., an ocean, sea, lake or the like) prevailing winds blow from the body of water to the shore. The prevailing winds often bring odors from the waste water to residential areas.

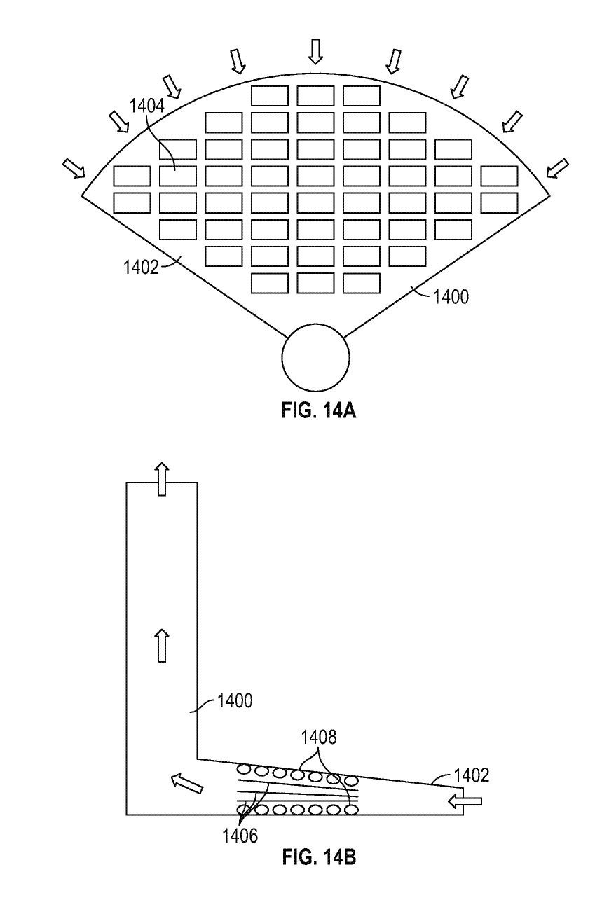

In another example a fan-shaped cleaning system 1400 is faces a body of water. The fan-shaped cleaning system 1400 is shown in FIGS. 14A, B. Optionally, the cleaning system 1400 is positioned behind a waste water processing plant. The fan-shaped system 1400 captures the odor gas from the waste water carried toward shore by the prevailing winds (shown with arrows in FIGS. 14A, B). The top of the shroud 1402 of the system 1400 is optionally covered with photovoltaic panels 1404. The heat generated by the PV panels 1404 increases the buoyancy of the gas (e.g., it rises) and thereby increases the gas flow through the system 1400.

Inside the system 1400, for instance within the shroud 1402, a set of parallel plates 1406 (e.g., glass or another translucent material) coated with a catalyzing substrate (described herein) is mounted. The parallel plates 1406 are optionally illuminated by UV lamps 1408 powered by the PV panels 1404 (or sunlight received through the shroud). The ultraviolet light causes the catalyzing substrate (e.g., nanomaterials, titanium dioxide or the like) to photo-oxidize the odor gases (e.g., hydrogen sulfite, organic volatile molecules or the like) and the precursor gases for secondary PM_{2.5}. In another example, ozone is also optionally generated in limited quantities that further assists in mitigation of odor.

### Various Notes & Examples

Example 1 can include subject matter, such as can include an adaptive spray cleaning system configured to clean a polluted gas, the system comprising: a gas tunnel including a gas inlet and a gas outlet; a gas mover in communication with the gas tunnel, the gas mover configured to move a polluted gas including one or more pollutants; a sprayer assembly between the gas inlet and the gas outlet, the sprayer assembly includes: at least one sprayer array having at least one spray nozzle, the at least one spray nozzle directed into the gas tunnel, and the sprayer assembly includes at least one variable spray configuration characteristic; and a sprayer assembly control system coupled with the at least one sprayer array, the sprayer assembly control system includes: one or more sensors proximate at least one of the gas inlet or the gas outlet, the one or more sensors are configured to measure a pollutant characteristic, and a controller in communication with the one or more sensors and the sprayer assembly, the controller is configured to control the at least one variable spray configuration characteristic according to the measured pollutant characteristic.

Example 2 can include, or can optionally be combined with the subject matter of Example 1, to optionally include wherein the gas mover includes a fan.

Example 3 can include, or can optionally be combined with the subject matter of one or any combination of Examples 1 or 2 to optionally include wherein the gas mover includes a passive gas mover.

Example 4 can include, or can optionally be combined with the subject matter of one or any combination of Examples 1-3 to optionally include wherein the one or more sensors include one or more sensors proximate each of the gas inlet and the gas outlet.

Example 5 can include, or can optionally be combined with the subject matter of one or any combination of Examples 1-4 to optionally include wherein the one or more sensors include a particulate counter.

Example 6 can include, or can optionally be combined with the subject matter of Examples 1-5 to optionally include wherein the one or more sensors include a chemical identification sensor.

Example 7 can include, or can optionally be combined with the subject matter of Examples 1-6 to optionally include wherein the one or more sensors include one or more of a flow rate sensor, velocity sensor, thermometer, hygrometer, particle counter, particle sizer, photometer, gas analyzer or transmissometer.

Example 8 can include, or can optionally be combined with the subject matter of Examples 1-7 to optionally include wherein the at least one sprayer array includes a plurality of nozzles.

Example 9 can include, or can optionally be combined with the subject matter of Examples 1-8 to optionally include wherein a nozzle density of the nozzles of the plurality of nozzles increases from proximate a perimeter of the gas tunnel toward a center of the gas tunnel.

Example 10 can include, or can optionally be combined with the subject matter of Examples 1-9 to optionally include wherein the one or more sensors are configured to measure a pollutant characteristic including one or more of particulate density, particulate size, pollutant identity, pollutant concentration, pollutant charge, polluted gas temperature, polluted gas flow rate, polluted gas velocity, polluted gas humidity.

Example 11 can include, or can optionally be combined with the subject matter of Examples 1-10 to optionally include wherein the at least one sprayer array includes first and second arrays of nozzles, the first array of nozzles is directed transversely relative to the gas tunnel at a first angle, and the second array of nozzles is directed transversely relative to the gas tunnel at a second angle different than the first angle.

Example 12 can include, or can optionally be combined with the subject matter of Examples 1-11 to optionally include wherein the at least one sprayer array includes first and second arrays of nozzles, the first array of nozzles is provided proximate a perimeter of the gas tunnel and a second array of nozzles is provide proximate a center of the gas tunnel, and the second array of nozzles includes more nozzles than the first array of nozzles.

Example 13 can include, or can optionally be combined with the subject matter of Examples 1-12 to optionally include wherein the at least one variable spray configuration includes nozzle array selection of at least the first and second arrays of nozzles, and the controller is configured to operate one or both of the first or second arrays of nozzles according to the measured pollutant characteristic.

Example 14 can include, or can optionally be combined with the subject matter of Examples 1-13 to optionally include wherein the at least one sprayer array includes first and second arrays of nozzles, the first array of nozzles is proximate the gas inlet relative to the second array of nozzles, the second array of nozzles is proximate the gas outlet relative to the first array of nozzles, and wherein the first array of nozzles is configured to spray fluid having first droplets of a first size and the second array of nozzles is configured to spray fluid having second droplets of a second size different than the first size.

Example 15 can include, or can optionally be combined with the subject matter of Examples 1-14 to optionally include wherein the at least one variable spray configuration characteristic consists of at least one of a nozzle density, nozzle direction, nozzle array selection, droplet size, droplet charge, spray fluid composition, spray fluid temperature and spray fluid output.

Example 16 can include, or can optionally be combined with the subject matter of Examples 1-15 to optionally include wherein the variable spray configuration characteristic includes at least a first value and a second value of the variable spray configuration characteristic, and the controller is configured to transition the sprayer assembly to one or both of the first and second values of the variable spray configuration characteristic according to the measured pollutant characteristic.

Example 17 can include, or can optionally be combined with the subject matter of Examples 1-16 to optionally include wherein the variable spray configuration characteristic includes a plurality of values of the variable spray configuration characteristic, and the controller is configured to transition the sprayer assembly to each of the plurality of values of the variable spray configuration characteristic according to the measured pollutant characteristic.

Example 18 can include, or can optionally be combined with the subject matter of Examples 1-17 to optionally include wherein the gas tunnel includes at least one catalyst substrate therein, the catalyst substrate configured to breakdown one or more pollutants in the polluted gas.

Example 19 can include, or can optionally be combined with the subject matter of Examples 1-18 to optionally include wherein the catalyst substrate consists of at least one of titanium dioxide, a photocatalyst, or a nanomaterial.

Example 20 can include, or can optionally be combined with the subject matter of Examples 1-19 to optionally include an adaptive spray cleaning system configured to clean a polluted gas, the system comprising: a tower including a gas tunnel therein, the gas tunnel includes a gas inlet and a gas outlet; a shroud extending from a base of the tower, the gas tunnel extends through the shroud; a sprayer assembly between the gas inlet and the gas outlet, the sprayer assembly includes: at least one sprayer array having at least one spray nozzle, the at least one spray nozzle directed into the gas tunnel, and the sprayer assembly includes at least one variable spray configuration characteristic; and a sprayer assembly control system coupled with the at least one sprayer array, the sprayer assembly control system includes: one or more sensors proximate at least one of the gas inlet or the gas outlet, the one or more sensors are configured to measure a pollutant characteristic, and a controller in communication with the one or more sensors and the sprayer assembly, the controller is configured to control the at least one variable spray configuration characteristic according to the measured pollutant characteristic.

Example 21 can include, or can optionally be combined with the subject matter of Examples 1-20 to optionally include wherein each of the tower and the shroud are configured for reception within a building.

Example 22 can include, or can optionally be combined with the subject matter of Examples 1-21 to optionally include wherein the shroud has a diameter of about 1 kilometer.

Example 23 can include, or can optionally be combined with the subject matter of Examples 1-22 to optionally include wherein the sprayer assembly is within the shroud.

Example 24 can include, or can optionally be combined with the subject matter of Examples 1-23 to optionally include wherein the sprayer assembly surrounds the tower and a portion of the gas tunnel within the tower.

Example 25 can include, or can optionally be combined with the subject matter of Examples 1-24 to optionally include wherein the one or more sensors include one or more sensors proximate each of the gas inlet and the gas outlet.

Example 26 can include, or can optionally be combined with the subject matter of Examples 1-25 to optionally include wherein the one or more sensors include one or more of a flow rate sensor, velocity sensor, thermometer, hygrometer, particle counter, particle sizer, photometer, gas analyzer or transmissometer.

Example 27 can include, or can optionally be combined with the subject matter of Examples 1-26 to optionally include wherein the at least one sprayer array includes a plurality of nozzles.

Example 28 can include, or can optionally be combined with the subject matter of Examples 1-27 to optionally include wherein a nozzle density of the nozzles of the plurality of nozzles increases from proximate a perimeter of the gas tunnel toward a center of the gas tunnel.

Example 29 can include, or can optionally be combined with the subject matter of Examples 1-28 to optionally include wherein the at least one sprayer array includes first and second arrays of nozzles, the first array of nozzles is directed transversely relative to the gas tunnel at a first angle, and the second array of nozzles is directed transversely relative to the gas tunnel at a second angle different than the first angle.

Example 30 can include, or can optionally be combined with the subject matter of Examples 1-29 to optionally include wherein the at least one sprayer array includes first and second arrays of nozzles, and the at least one variable spray configuration includes nozzle array selection of at least the first and second arrays of nozzles, and the controller is configured to operate one or both of the first or second arrays of nozzles according to the measured pollutant characteristic.

Example 31 can include, or can optionally be combined with the subject matter of Examples 1-30 to optionally include wherein the at least one variable spray configuration characteristic consists of at least one of a nozzle density, nozzle direction, nozzle array selection, droplet size, droplet charge, spray fluid composition, spray fluid temperature and spray fluid output.

Example 32 can include, or can optionally be combined with the subject matter of Examples 1-31 to optionally include wherein the variable spray configuration characteristic includes at least a first value and a second value of the variable spray configuration characteristic, and the controller is configured to transition the sprayer assembly to one or both of the first and second values of the variable spray configuration characteristic according to the measured pollutant characteristic.

Example 33 can include, or can optionally be combined with the subject matter of Examples 1-32 to optionally include wherein the variable spray configuration characteristic includes a plurality of values of the variable spray configuration characteristic, and the controller is configured to transition the sprayer assembly to each of the plurality of values of the variable spray configuration characteristic according to the measured pollutant characteristic.

Example 34 can include, or can optionally be combined with the subject matter of Examples 1-33 to optionally include wherein the gas tunnel includes at least one catalyst substrate therein, the catalyst substrate configured to breakdown one or more pollutants in the polluted gas.

Example 35 can include, or can optionally be combined with the subject matter of Examples 1-34 to optionally include a method for adaptively cleaning a polluted gas comprising: moving the polluted gas through a gas tunnel, the gas tunnel includes a gas inlet and a gas outlet; measuring at least one pollutant characteristic of the polluted gas; and removing at least one pollutant from the polluted gas with a sprayer assembly having at least one sprayer array with at least one spray nozzle, removing the at least one pollutant includes: controlling at least one variable spray configuration characteristic according to the measuring of the at least one pollutant characteristic, spraying the stream of polluted gas with a spray fluid from the at least one sprayer array according to the controlled variable spray configuration characteristic, and treating the at least one pollutant with the spray fluid.

Example 36 can include, or can optionally be combined with the subject matter of Examples 1-35 to optionally include wherein moving the stream of polluted gas through the gas tunnel includes active blowing of the stream of polluted gas.

Example 37 can include, or can optionally be combined with the subject matter of Examples 1-36 to optionally include wherein measuring the at least one pollutant characteristic includes measuring the at least one pollutant characteristic proximate to one or more of the gas inlet or the gas outlet.

Example 38 can include, or can optionally be combined with the subject matter of Examples 1-37 to optionally include wherein measuring the at least one pollutant characteristic includes measuring the at least one pollutant characteristic proximate to each of the gas inlet or the gas outlet.

Example 39 can include, or can optionally be combined with the subject matter of Examples 1-38 to optionally include wherein measuring of the at least one pollutant characteristic includes ongoing measuring of the at least one pollutant characteristic, and controlling the at least one variable spray configuration characteristic includes feedback controlling the at least one variable spray configuration characteristic according to the ongoing measuring.

Example 40 can include, or can optionally be combined with the subject matter of Examples 1-39 to optionally include wherein the at least one pollutant characteristic includes particulate count, controlling at least one variable spray configuration characteristic includes controlling a droplet size for the spray fluid according to the measured particulate count, and spraying the polluted gas with the spray fluid includes spraying the polluted gas with the droplet size corresponding to the measured particulate count.

Example 41 can include, or can optionally be combined with the subject matter of Examples 1-40 to optionally include wherein controlling the droplet size includes: selecting a first droplet size with the measurement of a first particulate count, and selecting a second droplet size with the measurement of a second particulate count, wherein the second particulate count is greater than the first particulate count and the second droplet size is smaller than the first droplet size.

Example 42 can include, or can optionally be combined with the subject matter of Examples 1-41 to optionally include wherein the at least one pollutant characteristic includes particulate density, controlling at least one variable spray configuration characteristic includes controlling a nozzle density according to the measured particulate density, and spraying the polluted gas with the spray fluid includes spraying the polluted gas with a plurality of nozzles corresponding to the nozzle density.

Example 43 can include, or can optionally be combined with the subject matter of Examples 1-42 to optionally include wherein controlling the nozzle density includes: selecting a first nozzle array with the measurement of a first particulate density, and selecting a second nozzle array with the measurement of a second particulate density, wherein the second density is greater than the first particulate density and the second nozzle array includes a greater number of nozzles than the first nozzle array.

Example 44 can include, or can optionally be combined with the subject matter of Examples 1-43 to optionally include wherein the at least one pollutant characteristic includes a pollutant concentration, and the spray fluid includes a variable concentration of a pollutant treating additive, controlling at least one variable spray configuration characteristic includes controlling the variable concentration of the pollutant treating additive in the spray fluid according to the measured pollutant concentration, and spraying the polluted gas with the spray fluid includes spraying the polluted gas with the spray fluid including the pollutant treating additive in the controlled variable concentration corresponding to the measured pollutant concentration.

Example 45 can include, or can optionally be combined with the subject matter of Examples 1-44 to optionally include wherein controlling the variable concentration includes: selecting a first variable concentration with the measurement of a first pollutant concentration, and selecting a second variable concentration with the measurement of a second pollutant concentration, wherein the second pollutant concentration is greater than the first pollutant concentration and the second variable concentration of the pollutant treating additive is greater than the first variable concentration.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the disclosure can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

1. An adaptive spray cleaning system configured to clean a polluted gas, the system comprising:
a gas tunnel including a gas inlet and a gas outlet;
a gas mover in communication with the gas tunnel, the gas mover configured to move a polluted gas including one or more pollutants;
a sprayer assembly between the gas inlet and the gas outlet, the sprayer assembly includes:
at least one sprayer array having at least one spray nozzle, the at least one spray nozzle directed into the gas tunnel, and
the sprayer assembly includes at least one variable spray configuration characteristic; and
a sprayer assembly control system coupled with the at least one sprayer array, the sprayer assembly control system includes:
one or more sensors proximate at least one of the gas inlet or the gas outlet, the one or more sensors are configured to measure a pollutant characteristic, and
a controller in communication with the one or more sensors and the sprayer assembly, the controller is configured to control the at least one variable spray configuration characteristic according to the measured pollutant characteristic.

2. (canceled)

3. (canceled)

4. (canceled)

5. The system of claim 1, wherein the one or more sensors include a particulate counter.

6. The system of claim 1, wherein the one or more sensors include a chemical identification sensor.

7. The system of claim 1, wherein the one or more sensors include one or more of a flow rate sensor, velocity sensor, thermometer, hygrometer, particle counter, particle sizer, photometer, gas analyzer or transmissometer.

8. The system of claim 1, wherein the at least one sprayer array includes a plurality of nozzles.

9. The system of claim 8, wherein a nozzle density of the nozzles of the plurality of nozzles increases from proximate a perimeter of the gas tunnel toward a center of the gas tunnel.

10. The system of claim 1, wherein the one or more sensors are configured to measure a pollutant characteristic including one or more of particulate density, particulate size, pollutant identity, pollutant concentration, pollutant charge, polluted gas temperature, polluted gas flow rate, polluted gas velocity, polluted gas humidity.

11. The system of claim 1, wherein the at least one sprayer array includes first and second arrays of nozzles,
the first array of nozzles is directed transversely relative to the gas tunnel at a first angle, and
the second array of nozzles is directed transversely relative to the gas tunnel at a second angle different than the first angle.

12. The system of claim 1, wherein the at least one sprayer array includes first and second arrays of nozzles,
the first array of nozzles is provided proximate a perimeter of the gas tunnel and a second array of nozzles is provided proximate a center of the gas tunnel, and
the second array of nozzles includes more nozzles than the first array of nozzles.

13. The system of claim 12, wherein the at least one variable spray configuration includes nozzle array selection of at least the first and second arrays of nozzles, and
the controller is configured to operate one or both of the first or second arrays of nozzles according to the measured pollutant characteristic.

14. (canceled)

15. The system of claim 1, wherein the at least one variable spray configuration characteristic consists of at least one of a nozzle density, nozzle direction, nozzle array selection, droplet size, droplet charge, spray fluid composition, spray fluid temperature and spray fluid output.

16. The system of claim 15, wherein the variable spray configuration characteristic includes at least a first value and a second value of the variable spray configuration characteristic, and
the controller is configured to transition the sprayer assembly to one or both of the first and second values of the variable spray configuration characteristic according to the measured pollutant characteristic.

17. (canceled)

18. (canceled)

19. (canceled)

20. An adaptive spray cleaning system configured to clean a polluted gas, the system comprising:
a tower including a gas tunnel therein, the gas tunnel includes a gas inlet and a gas outlet;
a shroud extending from a base of the tower, the gas tunnel extends through the shroud;
a sprayer assembly between the gas inlet and the gas outlet, the sprayer assembly includes:
at least one sprayer array having at least one spray nozzle, the at least one spray nozzle directed into the gas tunnel, and
the sprayer assembly includes at least one variable spray configuration characteristic; and
a sprayer assembly control system coupled with the at least one sprayer array, the sprayer assembly control system includes:
one or more sensors proximate at least one of the gas inlet or the gas outlet, the one or more sensors are configured to measure a pollutant characteristic, and
a controller in communication with the one or more sensors and the sprayer assembly, the controller is configured to control the at least one variable spray configuration characteristic according to the measured pollutant characteristic.

21. (canceled)

22. (canceled)

23. The system of claim 20, wherein the sprayer assembly is within the shroud.

24. (canceled)

25. (canceled)

26. (canceled)

27. The system of claim 20, wherein the at least one sprayer array includes a plurality of nozzles.

28. The system of claim 27, wherein a nozzle density of the nozzles of the plurality of nozzles increases from proximate a perimeter of the gas tunnel toward a center of the gas tunnel.

29. The system of claim 20, wherein the at least one sprayer array includes first and second arrays of nozzles,
the first array of nozzles is directed transversely relative to the gas tunnel at a first angle, and
the second array of nozzles is directed transversely relative to the gas tunnel at a second angle different than the first angle.

30. The system of claim 20, wherein the at least one sprayer array includes first and second arrays of nozzles, and the at least one variable spray configuration includes nozzle array selection of at least the first and second arrays of nozzles, and
the controller is configured to operate one or both of the first or second arrays of nozzles according to the measured pollutant characteristic.

31. The system of claim 20, wherein the at least one variable spray configuration characteristic consists of at least one of a nozzle density, nozzle direction, nozzle array selection, droplet size, droplet charge, spray fluid composition, spray fluid temperature and spray fluid output.

32. (canceled)

33. The system of claim 31, wherein the variable spray configuration characteristic includes a plurality of values of the variable spray configuration characteristic, and
the controller is configured to transition the sprayer assembly to each of the plurality of values of the variable spray configuration characteristic according to the measured pollutant characteristic.

34-45. (canceled)
